(19) United States
(12) Patent Application Publication
(10) Pub. No.: US 2023/0174166 A1
(43) Pub. Date: Jun. 8, 2023

(54) BODY UNIT, BODY AND VEHICLE AND METHOD FOR PRODUCTION THEREOF

(71) Applicants: Oliver Radl, Bad Urach (DE); Marco Schrade, Hayingen (DE)

(72) Inventors: Oliver Radl, Bad Urach (DE); Marco Schrade, Hayingen (DE)

(73) Assignee: ElringKlinger AG, Dettingen (DE)

(21) Appl. No.: 18/162,993

(22) Filed: Feb. 1, 2023

Related U.S. Application Data
(63) Continuation of application No. PCT/EP2021/071145, filed on Jul. 28, 2021.

(30) Foreign Application Priority Data
Aug. 3, 2020 (DE) 102020120452.3

(51) Int. Cl. B62D 29/04; B62D 29/00

(52) U.S. Cl. CPC B62D 29/043; B62D 29/004

(57) ABSTRACT

In order to improve a body unit comprising a body component that comprises an elongate carrier element and at least one injection molded part, it is proposed that at least one injection molded part that is molded onto the carrier element should hold at least one functional element at a holding part of the functional element.

### CROSS-REFERENCE TO RELATED PATENT APPLICATION

This application is a continuation of international application number PCT/EP2021/071145 filed on Jul. 28, 2021, and claims the benefit of German application No. DE 10 2020 120 452.3 filed on Aug. 3, 2020.

This patent application relates to the subject matter disclosed in and claims the benefit of international application PCT/EP2021/071145, filed Jul. 28, 2021, and German application No. DE 10 2020 120 452.3, filed Aug. 3, 2020, the teachings and disclosure of which are hereby incorporated in their entirety by reference thereto for all purposes.

### BACKGROUND OF THE INVENTION

The invention relates to a body unit comprising a body component, wherein the body component comprises an elongate carrier element and at least one injection molded part.

Furthermore, the invention relates to a method for the manufacture of a body unit.

The invention also relates to a body and a vehicle, and to a method for the manufacture thereof.

The object of the invention is to provide an improved body unit and/or body and/or vehicle, and as an alternative or in addition to provide an improved method for the manufacture of a body unit and/or body and/or vehicle.

### SUMMARY OF THE INVENTION

According to the invention, this object is achieved in that at least one injection molded part that is molded onto the carrier element holds at least one functional element on a holding part of the functional element.

An advantage of the solution can be seen in that, as a result of the held functional element, the body component can fulfill a further function, and because the molded-on injection molded part holds this functional element, a low-cost solution is provided.

More detailed statements have not yet been made as regards the holding part.

It is particularly favorable if the holding part is embedded in the injection molded part, in particular in a holding component thereof. In particular, this has the effect that, as a result of embedding the holding part, the functional element is held particularly stably and is preferably also prevented from rotating.

It is particularly advantageous if the holding part comprises a flange portion or a plurality of flange portions at which the injection molded part holds the functional element. For example, the one flange portion or the plurality of flange portions provide(s) a large surface area for the purpose of being held by the injection molded part over a large surface, with the result that the injection molded part can favorably hold the functional element securely and properly prevented from rotating.

In this case, the one flange portion and/or the plurality of flange portions may take the most diverse forms. In the text below, where the wording states that at least one flange portion has a feature, it should in particular be understood that the one flange portion or one flange portion of the plurality of flange portions has this feature, or preferably some, for example all, of the plurality of flange portions have this feature.

In some advantageous embodiments, at least some of the plurality of flange portions have the same combination of features.

In some favorable embodiments, it is provided for at least two flange portions of the plurality of flange portions to have at least one feature that is different, for example different combinations of features.

In particular, at least one flange portion takes the form of a flat flange portion.

It is particularly advantageous if at least one flange portion has mutually opposing flat sides at which the injection molded part holds the holding part and thus also the functional element. This has the effect in particular that, because the at least one flange portion is held over large surface areas by the injection molded part at the opposing flat sides, the injection molded part holds it particularly stably, and rotation thereof and/or distortion of the connection between the injection molded part and the functional element can be at least reduced or even entirely prevented.

In this context, it is particularly advantageous if at least portions of the injection molded part are molded onto at least one flat side, in particular onto both of the opposing flat sides, over the entire surface, such that the connection between the injection molded part and the functional element is particularly stable.

Preferably, a plurality of flange portions are arranged on one another.

Preferably, at least two flange portions are arranged transversely to one another, in particular at least approximately perpendicular to one another, and in particular also arranged on one another, as a result of which the injection molded part holds the holding part in a manner acting in various directions and so the connection preferably withstands the most diverse loads.

For example, the holding part is substantially formed by the one flange portion or by the plurality of flange portions.

In particularly favorable embodiments, it is provided for the holding part to have at least three flange portions.

In this case, it is particularly advantageous if the at least three flange portions at least substantially form the holding part. For example, in this case a flange portion is arranged between the other two flange portions and connected to these.

In particularly advantageous embodiments, it is provided for the holding part to have an undercut or a plurality of undercuts, as a result of which for example the connection between the injection molded part and the holding part is reinforced.

In the text below, where the wording states that at least one undercut has a feature, it should in particular be understood that the one undercut or one of the plurality of undercuts has the feature, or preferably some, for example all, of the plurality of undercuts have the feature. The plurality of undercuts may have the same or different combinations of features.

It is particularly advantageous if the injection molded part embraces at least one undercut and thus in particular an unwanted detaching of the functional element is at least made more difficult.

In this context, the at least one undercut may extend in the most diverse directions.

It is advantageous if at least one undercut is an undercut transverse, for example at least approximately perpendicular, to a direction of a longitudinal extent of the carrier element, such that detaching of the functional element and/or relative rotation in relation to the longitudinal direction is at least made more difficult.

In particularly favorable embodiments, it is provided for at least one undercut to be an undercut in relation related to a direction oriented from the holding part toward the carrier element, as a result of which in particular holding of the functional element by the injection molded part is reinforced in respect of a tensile load.

It is favorable if the holding part has at least one wall portion that runs at least approximately parallel to the longitudinal extent of the carrier element.

For example, the wall portion is also a flange portion.

In favorable embodiments, the wall portion is a portion of a molded element of the holding part that is in particular molded onto at least one flange portion or is shaped out of at least one flange portion.

For example, the molded element is a rib and/or an indentation or recessed element and/or a molded-on projection or a molded element that is molded on or shaped with the aid of another mold.

In particular, the at least one wall portion has a side remote from the carrier element, and at least one portion of the injection molded part covers this remote side at least partly, in particular over the entire surface. For example, the covering portion of the injection molded part is molded onto the remote side of the wall portion.

It is an advantage in this case for example that as a result of the fact that the remote side of the wall portion is at least partly covered, the functional element is supported stably and held in the direction toward the carrier element.

For example, an opposite side of the wall portion to the remote side is also covered by a portion of the injection molded part, with the result that preferably the wall portion is embedded in the injection molded part and in particular in this way stable mounting of the functional element is provided to resist pulls and pushes.

In particularly favorable embodiments, it is provided for the holding part to have one recessed element or a plurality of recessed elements.

In the text below, where the wording states that at least one recessed element has a feature, it should in particular be understood that the one recessed element or one of the plurality of recessed elements has this feature, or that preferably some, for example all, of the plurality of recessed elements have this feature. In particular, at least some of the plurality of recessed elements have the same feature or the same combination of features. In some favorable embodiments, at least some of the plurality of recessed elements have different features or different combinations of features.

It is particularly advantageous if the injection molded part engages at least in one recessed element by means of an engaging portion, wherein in particular this engagement produces particularly stable holding.

It is particularly favorable if, in the case of at least one recessed element, its internal walls are covered over their entire surface by the corresponding engaging portion of the injection molded part, and thus in particular stable holding is produced in a plurality of directions and preferably also in a manner preventing rotation.

Preferably, the engaging portion is molded onto the recessed element and its internal walls.

In particular, at least one recessed element extends from a starting side into the holding part as far as a base portion. In particular, portions with the internal walls extend from the starting side as far as the base portion, and the internal walls form for example a peripheral delimitation of the recessed element, relative to the direction of extent.

For example, the base portion is arranged in the holding part, in particular between the starting side of the holding part and an opposite side to this.

In favorable embodiments, the base portion forms the opposite side to the starting side, such that for example the recessed element extends from the starting side into the holding part as far as the opposite side, but is only open on the starting side and is closed on the opposite side.

In particularly advantageous embodiments, it is provided for the base portion to project beyond the opposite side to the starting side, such that in particular the recessed element projects partly beyond the opposite side. For example, this forms a deep recessed element, and the deeply engaging portion of the injection molded part can hold this particularly firmly.

Preferably, an opposite side of the recessed element to the starting side is covered by a portion of the injection molded part, in particular this portion being molded onto the opposite side. In this way, advantageously the injection molded part embraces the recessed element on both sides, as a result of which for example tensile and/or compressive loads and/or rotations can be withstood.

It is particularly advantageous if the part of the at least one recessed element that projects beyond the opposite side is covered over its entire surface on both sides by the injection molded part and, in particular as a result of this, is thus held particularly stably.

The one recessed element or the plurality of recessed elements may be formed at different locations on the holding part.

It is particularly advantageous if at least one recessed element is formed in at least one flange portion.

In particularly favorable embodiments, the holding part has an aperture or a plurality of apertures.

In the text below, where the wording states that at least one aperture has a feature, it should in particular be understood that the one aperture or one aperture of the plurality of apertures has this feature, or that preferably some, for example all, of the plurality of apertures have this feature. In particular, some of the plurality of apertures have the same feature or the same combination of features, and in some favorable embodiments some of the plurality of apertures have different features.

In particular, the injection molded part engages through at least one aperture such that mounting is particularly stable.

In particular, material of the injection molded part entirely fills at least one aperture.

In particular, an aperture opens on a respective side of the holding part by means of a respective through-opening, and extends continuously from the one through-opening to the other through-opening.

In particular, a respective through-opening of the at least one aperture is bordered by a respective border portion of the holding part.

It is particularly advantageous if the border portions are covered by the injection molded part at least partly, preferably over their entire surface, and if in particular these covering portions are molded onto the portion of the injection molded part that engages in the aperture. In this way, the engaging portion is held particularly stably, and advantageously good fixing of the functional element is provided.

The one aperture or the plurality of apertures may be provided at different locations on the holding part.

It is favorable if at least one flange portion has at least one aperture, in particular a multiplicity of apertures.

In particularly advantageous embodiments, it is provided for at least one recessed element to have at least one aperture. For example, this additionally reinforces stable holding of the recessed element by the additional engagement through the aperture.

For example, the at least one aperture is formed in an internal wall of the recessed element.

It is particularly favorable if the at least one aperture is formed in the base portion of the at least one recessed element.

It is particularly favorable if at least one flange portion has a multiplicity of apertures, and has one or more recessed elements with in each case at least one aperture.

For example, at least one aperture is an aperture that, in relation to its direction of extent through the holding element, is formed to be broad transversely thereto.

In other advantageous embodiments, at least one aperture takes a narrow form, with the result that its dimension transverse to its extent through the holding part is at least approximately in the same order of magnitude as a dimension between the two through-openings, in particular being less than five times the last-mentioned dimension, the dimensions being for example at least approximately the same size, or the transverse dimension being smaller than the dimension between the through-openings.

In particular, in this context the engaging portion of the injection molded part takes a form resembling a pin.

For example, the holding part comprises a projection or a plurality of projections.

In the text below, where the wording states that at least one projection has a feature, it should in particular be understood that the one projection or one of the plurality of projections has the feature, or that preferably some, for example all, of the projections have this feature.

For example, some of the plurality of projections have the same feature or the same combination of features, wherein in some advantageous embodiments some of the plurality of projections have different features or combinations of features.

In particular, the injection molded part at least partly embraces at least one projection, with the result that stable mounting is produced. Preferably in this case, it is provided for the injection molded part to embrace the at least one projection over its entire surface.

For example, at least one projection takes the form of a molded element and/or a projecting part of a recessed element, so in respect of further advantageous embodiments reference is made to the above explanations, wherein it is advantageously provided for at least one projection to have at least one of these above-explained features.

It is particularly advantageous if the holding part comprises a holding rib or a plurality of holding ribs.

An advantage thereof is for example that the one holding rib or the plurality of holding ribs enhance stability of the holding part and improve for example the connection between the holding part and the injection molded part.

In the text below, where the wording states that at least one holding rib has a feature, it should in particular be understood that the one holding rib or one of the plurality of holding ribs has the feature, preferably that some, for example all, of the holding ribs have the feature. In particular, at least some of the plurality of holding ribs have the same feature or the same combination of features, wherein for example some of the holding ribs have different features or combinations of features.

In particular, it is provided for the injection molded part to embrace at least one holding rib. In particular, this has the effect that the injection molded part holds the holding part firmly at a stabilized portion.

In particular, at least one holding rib comprises a rib portion or a plurality of rib portions.

It is favorable if at least one rib portion takes a form running in a direction running transverse to the longitudinal extent of the carrier element. Preferably, the injection molded part embraces this rib portion, and in particular the risk of rotations or displacements of the functional element transverse to the longitudinal extent of the carrier element is at least reduced by.

It is particularly advantageous if at least one holding rib has at least one rib portion that takes a form running in a direction running at least approximately parallel to the longitudinal extent of the carrier element. In particular, the injection molded part embraces this rib portion and, as a result of this, for example holds the functional element substantially at a predefined spacing from the carrier element.

It is particularly advantageous if at least one holding rib has at least two rib portions that run transversely to one another and are in particular arranged on one another. Preferably, the injection molded part embraces these transversely running rib portions and thus holds the functional element firmly in respect of a plurality of directions.

For example, one of the two transversely running rib portions is arranged in a central region of the other rib portion, such that the holding rib has a T-shaped cross section in this region.

It is particularly favorable if at least one holding rib has at least one undercut, wherein reference is made to the above statements in relation to advantageous embodiments of this.

For example, at least one holding rib forms at least one wall portion as explained above, so reference is made to the above explanations.

In preferred embodiments, it is provided for the holding part to have at least one receiving space in which the injection molded part engages. In particular, this produces stable fixing of the holding part by the injection molded part.

In particular, the holding part has one receiving space or a plurality of receiving spaces, wherein in the text below, where the wording states that at least one receiving space has a feature, it should in particular be understood that the one receiving space or one of the plurality of receiving spaces has this feature, or that some, for example all, of the plurality of receiving spaces have this feature. In the case of a plurality of receiving spaces, these may have the same feature or the same combination of features, and for example have one or more different features.

It is particularly favorable if the at least one receiving space is at least partly delimited by at least one flange portion.

For example, three flange portions delimit the receiving space on three sides.

It is particularly favorable if the at least one receiving space has at least one recessed element.

For example, at least one recessed element is formed extending away from the receiving space.

In advantageous embodiments, it is provided for at least one recessed element to project into the receiving space. In particular in this case, the starting side of the recessed element is thus arranged on an opposite side to the receiving space, and the recessed element projects into the receiving space.

Preferably, it is provided for at least one portion of the holding part that delimits the receiving space, for example a flange portion, to have at least one aperture, as a result of which for example fixing in the receiving space by the injection molded part is further reinforced.

It is particularly advantageous if at least one holding rib is arranged in the at least one receiving space. In particular, this reinforces the fixing connection between the injection molded part and the holding part. For example, this configuration is also favorable because in this way the holding rib is arranged in the receiving space such that overall volume is reduced, and in particular the holding rib does not project beyond an external contour of the functional element.

As an alternative or in addition, the above-mentioned object of the invention is also achieved in that, in the case of a body unit that comprises in particular one or more of the above-explained features, at least one injection molded part forms at least one functional element.

In particular, an advantage thereof can be seen in the fact that the body component is equipped with at least one functional element stably and at low cost.

It is particularly favorable if the at least one injection molded part taking the form of at least one functional element is molded onto the carrier element and thus, favorably, the functional element is arranged firmly on the carrier element, stably and in a structurally simple manner.

For example, the at least one injection molded part taking the form of at least one functional element has one or more of the above-explained features and/or embodiment options, as far as is correspondingly possible.

Preferably, the at least one injection molded part has a holding component by which the functional element is arranged on the carrier element. In this context, depending on the solution, it is provided in particular for the holding component and the functional element to be formed in one piece by the at least one injection molded part, or for the holding component to hold a separate functional element.

Preferably, the holding component is molded onto the carrier element.

Further statements have not yet been made as regards the functional element.

For example, the functional element is a functional element of a vehicle functional unit.

In other favorable embodiments, the functional element is for example a functional element of an equipment unit of the vehicle.

It is particularly favorable if the functional element takes the form of a securing element.

In particular, in preferred embodiments it is provided for the functional element to be formed for securing a vehicle functional unit and/or an equipment unit.

For example, the effect of this solution is that the vehicle functional unit can be secured stably to the body component and at the same time, because the functional element is held and/or formed by the injection molded part, a low-cost structural solution that saves on weight is provided.

For example, it is provided, in particular in the case of embodiments in which the functional element is held by the injection molded part, for the vehicle functional unit to be securable and secured to both the functional element and also a holding component of the injection molded part, and thus in particular for particularly stable securing to be produced. It is also possible to secure an equipment unit in this way.

In particular in the case of a body, in particular a motor vehicle having a body unit of this kind, it is provided for the vehicle functional unit and/or equipment unit to be secured at least to the functional element and for example also to be secured to the injection molded part, in particular the holding component thereof.

In particular, the vehicle functional unit is a functional element that is required for correct operation and driving of a vehicle having the body unit.

For example, the vehicle functional unit is a drive unit of a vehicle or part thereof.

In the case of some particularly favorable embodiments, it is provided for the vehicle functional unit to be at least a part of a steering system of a vehicle, for example at least a part of a steering column of the steering system.

In some advantageous embodiments, the vehicle functional unit is at least a part of an occupant protection system, for example an airbag system.

As an alternative or in addition, in the case of advantageous embodiments it is provided for the functional element to be formed for being secured to a further body component.

In particular, it is provided for the body unit to comprise at least one further body component and for preferably the at least one further body component to be secured to the functional element.

This produces for example stable securing of the body components, and advantageously enables securing to be made low-cost and low-weight as a result of the injection molded part.

Further statements have not yet been made as regards an arrangement of the functional element.

In different embodiments, the functional element may be arranged in different positions relative to the carrier element.

In some advantageous embodiments, it is provided for the functional element to be arranged, at least in one operating mode, in front of the carrier element as seen in a longitudinal direction of the vehicle.

In particular, the longitudinal direction of the vehicle corresponds at least approximately to a direction of travel of a vehicle having the body unit during straight-ahead travel.

In the text above and below, where the wording states that a feature is produced at least in one operating mode, it should in particular be understood that this feature is produced in the case of a correctly assembled body, in particular in the case of a correctly assembled vehicle having the body unit, and that the body unit takes a form such that this feature is produced if assembly is correct.

It is particularly favorable if the functional element is arranged at least in one operating mode in a front region of a body, in particular of a vehicle. In particular, this is favorable in order to perform correct operation in this region.

In particular, the front region is arranged in front of a driver-control region, and in particular in front of a passenger compartment, as seen in the longitudinal direction of the vehicle.

The driver-control region is in particular arranged in the passenger compartment, and is in particular the region that is provided for the driver and in which for example the driver's seat and control and/or operating elements for the driver, such as a steering wheel, are arranged.

In some particularly advantageous embodiments, it is provided for the at least one further body component to be a body component arranged between the front region and the driver-control region, in particular a front wall arranged in between, which separates off for example the driver-control region from the front region.

In particular, the body component has, on a side that faces the driver-control region at least in one operating mode, one or more mounting locations, which are formed for the purpose of securing control and/or operating elements for a driver, and to which control and/or operating elements are secured in particular in a fully assembled condition of the vehicle.

In some favorable embodiments, at least in one operating mode the functional element is arranged below the carrier element.

In some embodiments, the functional element is arranged on a side of the carrier element that at least in one operating mode faces a road surface.

For example, this is favorable in order to enable a connection with and/or securing to a floor structure of a body.

In particular in embodiments of this kind, the at least one further body component is a floor structure of the body, or at least a part thereof.

The functional element may also be manufactured from the most diverse materials.

In some advantageous embodiments, it is provided for at least part of the functional element, for example at least the holding part and/or a functional part, to be made from a material comprising a metal. In particular, substantially the entire functional element is made from a material comprising a metal.

It is particularly favorable if at least the holding part and/or a functional part, in particular the entire functional element, is made from metal.

This provides a particularly stable and resistant functional element which, in particular as a securing element, can particularly favorably withstand loads, such as vibrations during operation of the vehicle and/or the effects of impact in the event of an accident of a vehicle, and can preferably come through them substantially undamaged.

In this context, it is particularly favorable that, with the functional element of stable construction, the potentially damaging effects can be absorbed and at least reduced, and that because the functional element is held by the injection molded part a lightweight and low-cost solution is nonetheless produced.

For example, the metal comprises or is a steel.

In favorable embodiments, it is provided for the metal to comprise at least one light metal or to be a light metal, wherein the light metal comprises or is for example aluminum and/or magnesium.

In some preferred embodiments, it is provided for the functional element to be made at least partly, for example at least the holding part and/or a functional part, from a material comprising a plastics material, in particular substantially the whole functional element being made from a material comprising a plastics material.

For example, at least the holding part and/or a functional part, in particular the entire functional element, is substantially made from a plastics material.

This is in particular the case with solutions in which the injection molded part forms the at least one functional element, but it may also be provided for the injection molded part to hold a functional element made from a material comprising a plastics material.

It is particularly favorable if the functional element is at least partly fiber-reinforced. This may be provided in the case of functional elements made from different materials, and the fiber reinforcement may be performed by fibers embedded in the material of the functional element or by a reinforcing layer comprising fibers, as explained in more detail below.

In some favorable embodiments, it is provided for the functional element to be made at least partly, for example at least the holding part and/or a functional part, in particular the entire functional element, from a composite material.

For example, the composite material is a fiber-reinforced composite material.

As an alternative or in addition, the above-mentioned object of the invention is also achieved in that, in the case of a body unit that comprises in particular one or more of the above-explained features, at least one injection molded part comprises a reinforcing component, and the reinforcing component reinforces the carrier element.

In particular, an advantage thereof can be seen in that the carrier element may be reinforced by the reinforcing component in a structurally favorable manner, and, as a result of the injection molded part forming the reinforcing component, the reinforcement may be performed at reduced cost.

For example, as a result of the additional reinforcement the carrier element may be made such that there is less use of material and less weight, without this being at the expense of stability.

For example, the reinforcing component extends at least in certain portions along the carrier element, in particular at least approximately along at least a third, preferably at least a half, of the longitudinal extent of the carrier element. It is particularly favorable if the reinforcing component extends at least approximately along the entire longitudinal extent of the carrier element.

In particular, the reinforcing component extends along a portion or a plurality of portions of the carrier element at which functional elements or functional units or equipment units or similar are arranged on the carrier element in order to reinforce these portions of the carrier element, which are under greater load.

In some favorable embodiments, it is provided for the reinforcing component to extend at least along a portion of the carrier element that is on the driver's side at least in respect of one operating mode, since this portion is typically under greater load.

In particular, the driver-side portion of the carrier element is a portion of the carrier element that is associated with a driver's side of the body.

In particularly advantageous embodiments, it is provided for at least one injection molded part to comprise a reinforcing rib or a plurality of reinforcing ribs.

An advantage thereof can be seen in the fact that the one reinforcing rib or the plurality of reinforcing ribs reinforce the injection molded part and thus it is of more stable construction.

In the text below, where the wording states that at least one reinforcing rib has a feature, it should in particular be understood that the one reinforcing rib or one of the plurality of reinforcing ribs has the feature, or that preferably at least some, for example all, of the plurality of reinforcing ribs have the feature.

Preferably, in the case of a plurality of reinforcing ribs it is provided for at least some of the plurality of reinforcing ribs to have the same feature or the same combination of features.

In order to fulfill different functions, and/or in order to have a reinforcing effect to different extents, it is advantageous if some of the reinforcing ribs have a different feature or a different combination of features.

In some advantageous embodiments, the holding component of the injection molded part has at least one reinforcing rib, and this at least one reinforcing rib reinforces the holding component.

In particular, at least one reinforcing rib reinforces the carrier element, wherein at least this one reinforcing rib is part of the reinforcing component.

An advantage thereof can be seen in the fact that this additional reinforcement provides a particularly stable body component.

The one reinforcing rib or the plurality of reinforcing ribs may take the most diverse forms.

It is particularly favorable if at least one reinforcing rib at least partly peripherally embraces the carrier element. In particular, the arrangement of peripheral embracing in this case relates to a longitudinal extent of the carrier element, such that in particular the peripherally embracing reinforcing rib runs transversely to the longitudinal extent of the carrier element.

For example, the carrier element has a curved region.

It is particularly advantageous if at least one reinforcing rib is formed such that it runs at least in the one curved region of the carrier element and thus preferably reinforces the curved region.

For example, this reinforcing rib runs transversely to a direction of curvature of the curved region.

It is advantageous if this at least one reinforcing rib is formed such that it runs at least approximately in the direction of the direction of curvature.

It is particularly favorable if at least one reinforcing rib is formed such that it runs around the carrier element in a peripherally closed arrangement.

Preferably, it is provided for at least two reinforcing ribs to be formed such that they run transversely to one another, as a result of which in particular the stability, for example of the holding component and/or the carrier element having the reinforcing component, is enhanced.

It is particularly favorable if at least two reinforcing ribs, for example two reinforcing ribs that run transversely to one another, are formed such that they cross one another.

It is particularly advantageous if at least some reinforcing ribs of the plurality of reinforcing ribs are formed in the manner of a framework and in particular as a result develop a pronounced stabilizing effect.

In some particularly preferred embodiments, it is provided for at least one reinforcing rib to be formed such that it runs longitudinally along a longitudinal portion of the carrier element.

Preferably, it is provided for at least one reinforcing rib to be arranged in an internal region of the carrier element and thus for the carrier element to be reinforced particularly favorably, in particular such that overall volume is reduced.

In particularly advantageous embodiments, it is provided for at least some reinforcing ribs that run transversely to one another and/or cross one another to be arranged in the internal region of the carrier element.

In some embodiments, it is provided for the density of numbers of reinforcing ribs per unit length to be constant in individual portions, in particular along the longitudinal extent of the carrier element.

It is particularly preferable if the density of numbers of reinforcing ribs per unit length varies, in particular along the longitudinal extent of the carrier element, such that in particular portions that are to be particularly reinforced are particularly reinforced, and other portions have fewer reinforcing ribs, so manufacture of the body component in this region is simplified.

More detailed statements have not yet been made as regards configurations of the carrier element.

As an alternative or in addition, the above-mentioned object is also achieved in the case of a body unit that has in particular one or more of the above-explained features, in that the carrier element has a through-hole or a plurality of through-holes, and in that the at least one injection molded part engages in at least one through-hole.

In particular, the effect of the injection molded part engaging in at least one through-hole is that a connection between the injection molded part and the carrier element is particularly stable. In particular, as a result the injection molded part and for example also the functional element are held securely at the carrier element.

In the text above and below, where the wording states that at least one through-hole has a feature or that a feature is produced there, it should in particular be understood that the one through-hole or one of the plurality of through-holes has this feature, or that at least some, for example all, of the plurality of through-holes have this feature, or the feature is produced there.

In particular, at least some of the plurality of through-holes have the same feature or the same combination of features.

In some embodiments, it is favorable if at least some of the through-holes have a different feature or different combinations of features.

In particular, it is provided for at least one through-hole to be formed such that it runs through the carrier element transversely to the longitudinal extent of the carrier element.

It is particularly advantageous if, in the case of at least one through-hole, the injection molded part engages all the way through this and thus in particular has the effect of particularly stable fixing.

It is particularly favorable if, in the case of at least one through-hole, a portion of the injection molded part that engages in the through-hole is arranged, in particular directly, at a reinforcing rib of the injection molded part. For example, this additionally reinforces the engaging portion.

It is particularly advantageous if, in the case of at least one through-hole, a reinforcing rib of the injection molded part is formed such that it runs over a through-opening of the through-hole.

In particular, in the case of the at least one reinforcing rib that is formed to run over a through-opening, a portion of the injection molded part that engages in the through-hole is molded onto a portion of the reinforcing rib that runs over the through-opening.

It is particularly favorable if, in the case of at least one through-hole, the portion of the injection molded part that engages through the through-hole is molded at its respective ends onto a reinforcing rib, in the region of a corresponding through-opening.

More detailed statements have not yet been made as regards a form taken by the carrier element.

As an alternative or in addition, the object mentioned in the introduction is also achieved in the case of a body unit which has in particular one or more of the above-explained features, in that the carrier element comprises a plurality of longitudinal portions, wherein at least two longitudinal portions extend longitudinally at least approximately parallel to one another and are at a spacing from one another transversely to their longitudinal extent, and at least in certain portions an internal region of the carrier element is defined between the at least two longitudinal portions.

For example, an advantage thereof can be seen in that, by means of the at least two longitudinal portions and the internal region between them, there is produced a stable and at the same time weight-saving carrier element for the body component.

In particular, the internal region extends at least approximately along the entire longitudinal extent of the at least two longitudinal portions.

Preferably, the internal region is a hollow internal region, such that the saving on weight is made particularly favorable.

It is particularly advantageous if the carrier element comprises at least one further longitudinal portion, and this at least one further longitudinal portion connects the at least two mutually spaced longitudinal portions on one side of the internal region.

Preferably, the at least one further longitudinal portion is molded onto each of the two mutually spaced longitudinal portions. In particular, this provides a stable carrier element that saves on weight.

As an alternative or in addition, the object mentioned in the introduction is also achieved in the case of a body unit which in particular comprises one or more of the above-explained features, in that the carrier element has a laterally open cross-sectional shape.

In this case, the cross-sectional shape relates in particular to sections in geometric transverse planes that run at least approximately perpendicular to a direction of a longitudinal extent of the carrier element.

In particular, the carrier element, and preferably the entire body component, extend longitudinally along a component axis. In particular, the axial direction along the component axis corresponds to the direction of the longitudinal extent of the carrier element.

The cross-sectional shape relates in particular to sections that run at least approximately perpendicular to the component axis.

In particular, at least in one operating mode, the component axis runs transversely, for example at least approximately perpendicular, to the vehicle longitudinal axis.

In some embodiments, it may also be provided for the component axis to run obliquely or at least approximately parallel to the vehicle longitudinal axis.

It is particularly favorable if the carrier element takes a form that is open on a side that runs along the longitudinal extent of the carrier element.

For example, a longitudinal portion is arranged opposite the open side, transversely to the longitudinal extent of the carrier element.

In particular, the open side extends at least approximately along the entire longitudinal extent of the carrier element.

In particular, it is provided for the two transversely spaced longitudinal portions respectively to delimit the open side.

In particular, the open side of the carrier element is arranged opposite the at least one further longitudinal portion that connects the two spaced longitudinal portions.

It is particularly advantageous if portions of the at least one injection molded part, in particular reinforcing ribs thereof, border the open side at least in certain portions, with the result that in particular at the open side an additional reinforcement is produced by the injection molded part, in particular by its reinforcing component.

In some preferred embodiments, it is provided for the longitudinal portions of the carrier element to be planar in form, at least in certain portions, along their longitudinal extent, preferably being planar in form at least approximately along their entire extent.

In some favorable embodiments, it is provided for at least one longitudinal portion to be curved in form transversely to its longitudinal extent and thus to form a curved region of the carrier element.

In particular in the case of longitudinal portions that are at least approximately planar in form, it is provided for a region of the carrier element in which two of these longitudinal portions are molded onto one another to be curved in form and thus to form a curved region of the carrier element.

It is particularly advantageous if the carrier element has a C-shaped profile.

The carrier element may be made from the most diverse materials.

It is particularly favorable if the carrier element is made at least partly from a metallic material. For example, it is made at least approximately entirely from a metallic material.

In particular, the metallic material comprises steel, or the metallic material is steel. For example, this provides a stable and low-cost solution for the carrier element.

In advantageous solutions, it is provided for the metallic material to comprise or to be a light metal such as aluminum and/or magnesium. In particular, this enables a lightweight construction for the carrier element and the body component.

In particularly preferred embodiments, the carrier element made from the metallic material is reinforced by means of the reinforcing component of at least one injection molded part.

As an alternative or in addition, the object that is mentioned in the introduction and underlies the invention is achieved in the case of a body unit which in particular comprises one or more of the above-explained features, in that the carrier element of the body component is at least partly formed from an injection molded part.

In particular, an advantage thereof is that a low-cost solution that saves on weight is provided.

In some particularly favorable embodiments, it is provided for the carrier element to be formed substantially entirely as an injection molded part.

In particular in the case of these solutions, it is provided for the injection molded part that at least partly forms the carrier element also to form the holding component.

In particular, the carrier element is made at least partly from a material comprising plastics material. For example, it is made at least approximately entirely from a material comprising plastics material.

It is particularly advantageous if the plastics material of the carrier element material is a high-strength plastics material, with the result that the carrier element takes a particularly stable form.

For example, a high-strength plastics material has an elastic modulus that is at least in the same order of magnitude or is greater than an elastic modulus of a metal such as magnesium or aluminum.

In particular, the elastic modulus of the high-strength plastics material is at least approximately the same size as or greater than the elastic modulus of a metal such as magnesium or aluminum.

Preferably, the elastic modulus of the high-strength plastics material is greater than 5 gigapascal (GPa), in particular greater than 10 GPa, for example greater than 15 GPa.

For example, in some embodiments the elastic modulus of the high-strength plastics material is greater than 25 GPa.

In this way, it is possible to provide in particular a carrier element that is at least partly made from a plastics material, in particular a high-strength plastics material, that has a rigidity that is at least in the same order of magnitude, preferably at least approximately the same size as or greater than the rigidity of a corresponding carrier element made from a metallic material.

For example, polyether ether ketone is provided, as a particularly high-strength plastics material.

In particular, polyarylamide is provided, as a particularly high-strength plastics material that has particularly favorable handling properties and a large elastic modulus, and is relatively favorable for advantageous plastics materials.

It is also favorable to provide a polyamide as a plastics material, wherein some polyamides may also be provided as a high-strength plastics material.

In some favorable embodiments, polypropylene is used as a plastics material which in particular provides a low-cost solution.

In some particularly favorable embodiments, it is provided for the material of the carrier element to comprise at least two different materials.

An advantage thereof is for example that the carrier element may be formed with the respective material targeted to corresponding requirements. In particular, this may also provide a low-cost solution.

Thus, it is provided in particular for one of the at least two materials to have a greater elastic modulus than the other of the at least two materials. Preferably, as a result portions of the carrier element that are under higher load may be formed using the material having the greater elastic modulus, and portions under less load may for example be formed using a lower-cost material.

For example, the at least two different materials are a plastics material and a metallic material.

In particularly preferred embodiments, it is provided for the at least two different materials to be two different plastics materials.

This is particularly favorable if the carrier element is formed at least partly from the at least one injection molded part. For example, this may then favorably be manufactured by a multi-component injection molding method.

In particular, one of the at least two materials is a high-strength plastics material.

In some favorable embodiments, it is provided for the at least two different materials to be present in the carrier element as separate materials. For example, portions of the carrier element are then made from one of the at least two materials and other portions of the carrier element are made from the other of the at least two materials.

In other advantageous embodiments, it is provided for the at least two different materials to be present in the carrier element as merging materials. In particular, in this case there are portions of the carrier element that are formed by both of the at least two materials without there being a distinct separation between these at least two materials. For example, there is no macroscopic separating face between these at least two different materials. For example, regions that are made from a respective one of these two different materials merge into one another.

In particularly advantageous embodiments, it is provided for the carrier element to be formed from a composite material. In particular, this provides a low-cost and stable configuration for the carrier element.

In particular, the composite material comprises at least one metallic material and/or plastics material.

In addition or as an alternative, the object that is mentioned in the introduction and underlies the invention is achieved in that, in the case of a body unit that comprises in particular one or more of the above-explained features, the carrier element of the body component is at least partly fiber-reinforced.

In particular, an advantage thereof is that the carrier element is reinforced in a manner that saves on weight.

In some advantageous embodiments, the carrier element is made from a fiber-reinforced material, in particular a fiber-reinforced composite material.

In particular, the fiber-reinforced material of the carrier element comprises a metallic and/or a plastics material.

In some particularly advantageous embodiments, the carrier element is fiber-reinforced by a fiber-reinforced reinforcing component.

For example, an advantage thereof is that a low-cost carrier element may be used and may be reinforced in a structurally simple manner by the fiber-reinforced reinforcing component and may thus take a stable form.

In particular, the fiber-reinforced reinforcing component is a fiber-reinforced layer that is secured to the carrier element.

For example, the fiber-reinforced layer is arranged at least on a longitudinal portion of the carrier element.

In some particularly advantageous embodiments, the fiber-reinforced reinforcing component is formed by at least one injection molded part.

In particular, the carrier element is fiber-reinforced, at least in certain portions, along its entire longitudinal extent.

It is particularly favorable if the carrier element is formed to be fiber-reinforced at least along a portion that, at least in respect of one operating mode, is on the driver's side.

In some favorable embodiments, it is provided for the carrier element to be fiber-reinforced at least approximately along its entire longitudinal extent.

Further statements have not yet been made as regards further embodiment features of the at least one injection molded part, that is to say one injection molded part or a plurality of injection molded parts.

The body component may have one injection molded part or a plurality of injection molded parts, wherein in the text above and below, where the wording states that at least one injection molded part has a feature, it should in particular be understood that the one injection molded part or one of the plurality of injection molded parts has this feature, or that some, for example all, of the plurality of injection molded parts have this feature.

In some preferred embodiments, the body component has exactly one injection molded part, which has one or preferably a plurality of the features explained above and below and/or comprises a plurality of components.

In some advantageous embodiments, the body component comprises a plurality of injection molded parts, wherein these have one or preferably a plurality of the features explained above and below. For example, at least some of the plurality of injection molded parts have the same feature or the same combination of features. In particular, it may also be provided for at least some of the plurality of injection molded parts to have different features and/or different combinations of features.

The at least one injection molded part may be made from different materials, in particular from materials that can be reshaped by an injection molding method.

Preferably, the injection molded part is made from plastics material.

For example, the plastics material of the injection molded part is a high-strength plastics material. In particular, for an explanation of the high-strength plastics material, reference is made to the above explanations of the high-strength plastics material.

For example, the plastics material is a thermoset material.

In preferred embodiments, the plastics material is a thermoplastic material.

In some preferred embodiments, the injection molded part is made from exactly one plastics material, as a result of which for example a structurally simple solution is produced.

In other advantageous embodiments, it is provided for the injection molded part to be made from at least two different plastics materials.

In particular, an injection molded part of this kind made from a plurality of plastics materials is manufactured by a multi-component injection molding method.

Preferably, at least one of the two different plastics materials is a high-strength plastics material.

For example, one of the at least two different plastics materials is an in particular sufficiently stable low-cost plastics material.

In some advantageous embodiments, the at least two different plastics materials are present separately from one another, and in other advantageous embodiments the two different plastics materials merge into one another, wherein in respect of further features in this regard reference is made to the statements made in the context of the carrier element that is made from at least two different materials.

In respect of advantages and further preferred configurations of the injection molded part that is made from at least two different plastics materials, reference is made to the statements above in the context of the carrier element that is made from at least two different materials, in order to avoid repetition.

Preferably, it is provided for the at least one injection molded part, in particular its holding component and/or reinforcing component, to be molded onto the carrier element.

In particular, this is provided in the case of a carrier element that is made from a material comprising a metal and/or a composite material.

In particular, it is provided for the holding component and the reinforcing component of the at least one injection molded part to be made in one piece.

Further statements have not yet been made as regards further configurations of the body component.

In particular, the body component extends, in particular along the component axis, between two respective longitudinal ends.

Preferably, the carrier element also extends from the one longitudinal end to the other longitudinal end.

Preferably, the body component comprises a flange body at at least one of its longitudinal ends, in particular a respective flange body at each of its two longitudinal ends, wherein the one flange body or the two flange bodies take(s) a form for securing to at least one further body component.

In preferred embodiments of the body unit having at least one further body component, a further body component is secured to the one flange body, and preferably at least one further body component is secured in each case to both flange bodies.

In particular, it is provided for the one flange body or the two flange bodies to take the form of at least the carrier element and/or at least one injection molded part, preferably both.

In particular, at least a part of the reinforcing component forms, at least partly, the one flange body or both flange bodies.

More detailed statements have not yet been made as regards the fiber reinforcement.

A fiber reinforcement may be provided at different locations and components of the body component, in particular as explained above in the case of the holding component and/or reinforcing component of the injection molded part and/or in the case of the carrier element. In particular, in the case of these components and/or elements it is provided for this fiber reinforcement to comprise one or more of the features below.

In some advantageous embodiments, it is provided for fibers that are embedded in the component and/or element to form the fiber reinforcement. In particular, in this case it is thus provided for the element and/or component to be made from a material and for the fibers to be embedded in this material.

In some preferred embodiments, it is provided for the fiber reinforcement to take the form of a fiber-reinforced layer.

In particular, this fiber-reinforced layer is arranged on the corresponding element and/or component, in particular on an outer side thereof, such that this produces the fiber reinforcement.

In particular, the layer is a fiber-reinforced semi-finished product.

For example, the layer is a fiber-reinforced tape.

Preferably, the fibers of the layer are embedded in a plastics material, in particular a thermoplastic material.

For example, an advantage thereof can be seen in the fact that the corresponding component and/or element can be manufactured at low cost by standard methods and can be reinforced at low cost by securing of the fiber-reinforced layer.

In particular, the fibers of the fiber reinforcement are arranged in one ply or in a plurality of plies.

For example, at least two plies and/or at most ten plies are provided. In particular, three plies or four plies or five plies or six plies are provided.

In particular, each ply has a respective thickness of at least 1 μm, for example at least 5 μm and/or at most 100 μm, for example at most 50 μm.

The orientation of the fibers may differ, depending on the embodiment.

It is particularly favorable if the orientation of the fibers is arranged to correspond to load paths that occur on the component. Thus, the fibers are oriented in a manner suitable for the load paths, such that a high degree of stability is produced by the fibers oriented to correspond to the loading.

In particular, in some embodiments it is favorable if at least some of the fibers, for example fibers of at least one ply, are oriented unidirectionally.

For example, the fibers that are oriented unidirectionally are oriented along at least one load path, such that the fiber reinforcement has a particularly favorable effect along the loaded locations.

For example, in some embodiments it is provided for a plurality of plies to be provided with fibers that are oriented unidirectionally.

For example, the unidirectional directions of a plurality of plies run at least approximately parallel, such that a high level of stabilizing effect is produced in particular along a load path.

In other favorable embodiments, it is provided for the unidirectional directions of a plurality of plies to run transversely to one another, such that for example reinforcement is produced in a plurality of directions.

In some particularly preferred embodiments, it is provided for at least some fibers of the fiber reinforcement to be entwined with one another. For example, this can produce a particularly high level of stabilizing effect.

In particular, the entwined fibers cross one another.

For example, the entwined fibers form a woven and/or knitted and/or braided arrangement.

The most diverse fibers may be used for the fiber reinforcement.

In particular, it is provided for the fibers of the fiber reinforcement to comprise glass fibers. For example, this provides a low-cost fiber reinforcement.

In advantageous embodiments, it is provided for the fibers of the fiber reinforcement to comprise carbon fibers. An advantage thereof is for example that carbon fibers are light.

In particular, the fiber thickness of the fibers is at least 1 μm. For example, the fiber thickness is at most 100 μm, for example at most 50 μm.

In particular, a length of the fibers is at least 1 cm.

Preferably, continuous fibers are used for the fiber reinforcement.

It is particularly advantageous if the fibers of the fiber reinforcement have at least approximately a length corresponding to the length of the fiber-reinforced location, in particular to the dimension of the reinforcing component and/or holding component and/or to the longitudinal extent of the carrier element.

As an alternative or in addition, the object mentioned in the introduction is also achieved by a body for a motor vehicle which comprises a body component, in particular a body unit, having at least one, preferably a plurality of the above-explained features.

In particular, the body also comprises further body components to which the above-mentioned body component is secured, in particular as explained above.

As an alternative or in addition, the object mentioned in the introduction is also achieved by a motor vehicle which comprises a body component, in particular a body unit, preferably a body having at least one, preferably a plurality of the above-mentioned features.

As an alternative or in addition, the object mentioned in the introduction and underlying the invention is also achieved by a method for the manufacture of a body unit comprising a body component, wherein the method comprises providing an elongate carrier element and forming at least one injection molded part for the body component.

In particular in this context, it is provided for the body component, in particular the carrier element and/or at least one injection molded part and/or a functional element, to be provided with one or preferably a plurality of the above-explained features, wherein the above-mentioned advantages apply analogously to the method.

Preferably in the case of the method, a mold is used for the purpose of forming at least one injection molded part, wherein in particular the mold comprises a plurality of mold units.

In particular, the mold units each have at least one mold recess, wherein the mold recesses, at least in a molding position of the mold units in relation to one another, together delimit a molding cavity for the one or more injection molded parts.

In advantageous embodiments of the method, at least one insert is inserted into at least one mold recess of a mold unit, such that at least one injection molded part is molded onto this insert and in particular at least a part of the insert is embedded in at least one portion of the injection molded part.

For example, an advantage thereof can be seen in the fact that the body component may be manufactured from different parts in a structurally simple manner and may favorably be manufactured to be stable.

In some particularly preferred embodiments, it is provided for at least one insert to be the in particular metallic carrier element.

In some favorable embodiments, it is provided for at least one insert to be the in particular metallic functional element.

In some favorable embodiments, it is provided for reinforcement parts, for example fiber-reinforced layers and/or stabilizing metallic layers and/or stabilizing securing parts, to be inserts that are inserted into the mold recess.

This is particularly favorable if the injection molded part at least partly forms the carrier element, such that this is additionally reinforced by the inserts and/or may fulfill additional functions as a result of functional parts.

It is particularly advantageous if at least some of the plurality of mold units are movable in relation to one another. In particular, the at least some mold units are movable in relation to one another in a plurality of directions.

For example, this simplifies fitting inserts onto the functional units and moving the mold units into the relative arrangement of the inserts that is provided for the body component.

In particular, at least some mold units are movable in relation to one another and relative to a mold plane.

It is particularly favorable if at least some mold units are movable in relation to one another obliquely and/or at least approximately parallel to the mold plane.

It is particularly advantageous if at least one mold unit has a mold slide that is displaceable in relation to a mold unit base.

In particular, the mold slide at least partly forms the mold recess in the mold unit. For example, the mold unit base at least partly forms the mold recess in the mold unit.

An advantage thereof can be seen for example in the fact that the mold slide allows more complex molding cavities to be formed, wherein in particular undercuts may be formed and/or formations of at least one injection molded part may be formed in internal regions of an element of the body component, in particular the carrier element.

In particular as a result of such mold units, it is possible for body components having one or more features as explained above to be formed.

In advantageous embodiments, it is provided for the formation of at least one injection molded part to comprise multi-component injection molding. For example, an advantage of the multi-component injection molding method is that the at least one injection molded part can be manufactured from a plurality of components in a simple manner.

In particular in the case of the multi-component injection molding method, a plurality of injection molding materials, preferably at least two different plastics materials, are injected into the molding cavity in one injection procedure.

As an alternative or in addition, the object mentioned in the introduction and underlying the invention is also achieved by a method for the manufacture of a body, wherein during manufacture of the body at least one body unit is manufactured in accordance with one or more of the above-explained method steps and/or at least one body unit and/or at least one body component of the body is provided with one or more of the above-explained features.

As an alternative or in addition, the object mentioned in the introduction and underlying the invention is also achieved by a method for the manufacture of a motor vehicle, wherein this method comprises manufacture of a body having at least one body unit and/or at least one body component with preferably one or a plurality of the above-explained features and/or in accordance with one or more of the above-explained method steps.

In the text above and below, where the wording “at least approximately” is used in conjunction with a specification, it should in particular be understood that this is inclusive of deviations from the specification that are the result of technical constraints and/or that are technically irrelevant. For example, where values are specified, this is inclusive in particular of deviations of up to ±20%, preferably up to ±10%, for example up to ±5%, of the value. In particular in the case of specifications of directions, in particular in the case of a specification of at least approximately parallel and/or at least approximately perpendicular, this is inclusive in particular of deviations of up to ±20%, preferably up to ±10%, for example up to ±5%.

In the text above and below, where the wording states that a value is at least in the same order of magnitude as another value, it should in particular be understood to mean that this value differs from the other value by at most a factor of 10, for example at most a factor of 5.

Thus, the description above of inventive solutions comprises in particular the different combinations of features that are defined by the sequentially numbered embodiments below:

1. A body unit, comprising a body component (210) that comprises an elongate carrier element (212) and at least one injection molded part (214), wherein at least one injection molded part (214) that is molded onto the carrier element (212) holds at least one functional element (410) at a holding part (412) of the functional element (410).
2. The body unit according to embodiment 1, wherein the holding part (412) is embedded in the injection molded part (214).
3. The body unit according to one of the preceding embodiments, wherein the holding part (412) comprises a flange portion (442, 444, 446) or a plurality of flange portions (442, 444, 446) at which the injection molded part (214) holds the functional element (212).
4. The body unit according to the preceding embodiment, wherein at least one flange portion (442, 444, 446) has mutually opposing flat sides at which the injection molded part (214) holds the functional element.
5. The body unit according to the preceding embodiment, wherein at least portions of the injection molded part (214) are molded onto at least one flat side, in particular onto both of the opposing flat sides, over the entire surface.
6. The body unit according to one of the three preceding embodiments, wherein at least two flange portions (442, 444, 446) are arranged on one another and transversely to one another, in particular at least approximately perpendicular to one another.
7. The body unit according to one of the four preceding embodiments, wherein the holding part (412) has at least three flange portions (442, 444, 446), which in particular at least substantially form the holding part (412).
8. The body unit according to one of the preceding embodiments, wherein the holding part (412) has an undercut or a plurality of undercuts, and the injection molded part (214) embraces at least one undercut.
9. The body unit according to the preceding embodiment, wherein at least one undercut is an undercut in relation related to a direction oriented from the holding part (412) toward the carrier element (212).
10. The body unit according to one of the preceding embodiments, wherein the holding part (412) has at least one wall portion that runs at least approximately parallel to a longitudinal extent of the carrier element (212), and at least one portion of the injection molded part (214) at least partly, in particular over the entire surface, covers at least a side of the wall portion remote from the carrier element (212), in particular being molded onto this remote side.
11. The body unit according to one of the preceding embodiments, wherein the holding part (412) has one recessed element (462, 464) or a plurality of recessed elements (462, 464), and wherein the injection molded part (214) engages at least in one recessed element (462, 464) with an engaging portion (478).
12. The body unit according to the preceding embodiment, wherein, in the case of at least one recessed element (462, 464), its internal walls (468) are covered over their entire surface by the corresponding engaging portion (478) of the injection molded part (214), in particular this being molded onto them.
13. The body unit according to one of the two preceding embodiments, wherein, in the case of at least one recessed element (462, 464), a base portion (472) thereof, as far as which the recessed element (462, 464) extends from a starting side into the holding part (412), projects beyond an opposite side to the starting side.
14. The body unit according to the preceding embodiment, wherein the part of the at least one recessed element (462, 464) that projects beyond the opposite side is covered over its entire surface on both sides by the injection molded part (214).
15. The body unit according to one of the four preceding embodiments, wherein at least one recessed element (462, 464) is formed in at least one flange portion (442, 444, 446).
16. The body unit according to one of the preceding embodiments, wherein the holding part (412) has an aperture (482, 484) or a plurality of apertures (482, 484), and wherein the injection molded part (214) engages through at least one aperture (482, 484).
17. The body unit according to the preceding embodiment, wherein, in the case of at least one aperture (482, 484), border portions (492, 494) that border a respective through-opening (486, 488) of the aperture (482, 484) on a respective side of the holding part (412) are covered over their entire surface by the injection molded part (214).
18. The body unit according to one of the two preceding embodiments, wherein at least one flange portion (442, 444, 446) has at least one aperture (482, 484).
19. The body unit according to one of the three preceding embodiments, wherein at least one recessed element (462, 464) has at least one aperture (482, 484), in particular in its base portion (472).
20. The body unit according to one of the preceding embodiments, wherein the holding part (412) comprises a holding rib (512) or a plurality of holding ribs (272, 274, 276), and wherein the injection molded part (214) embraces at least one holding rib (512).
21. The body unit according to the preceding embodiment, wherein at least one holding rib (512) has at least two rib portions (492, 494) that run transversely to one another.
22. The body unit according to one of the preceding embodiments, wherein the holding part (412) has at least one receiving space (448) in which the injection molded part (214) engages.
23. The body unit according to the preceding embodiment, wherein the at least one receiving space (448) is at least partly delimited by at least one flange portion (442, 444, 446).
24. The body unit according to one of the two preceding embodiments, wherein the at least one receiving space (448) has at least one recessed element (462, 464), wherein in particular the recessed element (462, 464) projects into the receiving space (448).
25. The body unit according to one of the three preceding embodiments, wherein at least one portion of the holding part (412) that delimits the receiving space (448) has at least one aperture (482, 484).
26. The body unit according to one of the four preceding embodiments, wherein at least one holding rib (512) is arranged in the at least one receiving space (448).
27. A body unit, comprising a body component (210) that comprises an elongate carrier element (212) and at least one injection molded part (214), in particular comprising one or more features of one of the preceding embodiments, wherein at least one injection molded part (214′) forms at least one functional element (410′).
28. The body unit according to the preceding embodiment, wherein the at least one injection molded part (214′) forming at least one functional element (410′) is molded onto the carrier element (212).
29. The body unit according to one of the preceding embodiments, wherein the functional element (410, 410′) takes the form of a securing element, in particular for securing a vehicle functional unit.
30. The body unit according to one of the preceding embodiments, wherein the functional element (410, 410′) takes the form of a securing element for being secured to a further body component.
31. The body unit according to one of the preceding embodiments, wherein the body unit comprises at least one further body component, and wherein the at least one further body component is secured to the functional element.
32. The body unit according to one of the preceding embodiments, wherein the functional element (410, 410′) is arranged, at least in respect of one operating mode, in front of the carrier element (212) as seen in a longitudinal direction (138) of the vehicle.
33. The body unit according to one of the preceding embodiments, wherein the functional element (410, 410′) is arranged, at least in respect of one operating mode, on an opposite side of the body component (210, 210′) to a driver-control region (152).
34. The body unit according to one of the preceding embodiments, wherein the at least one functional element (410, 410′) is at least partly, for example at least the holding part (412), made from metal.
35. The body unit according to one of the preceding embodiments, wherein the functional element (410, 410′) is at least partly fiber-reinforced.
36. A body unit, comprising a body component (210) that comprises an elongate carrier element (212) and at least one injection molded part (214), in particular comprising one or more features of one of the preceding embodiments, wherein at least one injection molded part (214, 214′) comprises a reinforcing component (272) that reinforces the carrier element (212).
37. The body unit according to one of the preceding embodiments, wherein at least one injection molded part (214, 214′) comprises a reinforcing rib (274, 276, 278) or a plurality of reinforcing ribs (274, 276, 278), and wherein in particular at least one reinforcing rib (274, 276, 278) reinforces the carrier element (212) and/or at least one reinforcing rib (274, 276, 278) reinforces a holding component (412) of at least one injection molded part (214, 214′).
38. The body unit according to the preceding embodiment, wherein at least one reinforcing rib (274, 276, 278) at least partly peripherally embraces the carrier element (212).
39. The body unit according to one of the two preceding embodiments, wherein at least two reinforcing ribs (274, 276, 278) are formed such that they run transversely to one another, in particular crossing one another.
40. The body unit according to one of the three preceding embodiments, wherein at least one reinforcing rib (274, 276, 278) is formed such that it runs longitudinally along a longitudinal portion (222, 224, 226) of the carrier element.
41. The body unit according to one of the four preceding embodiments, wherein at least one reinforcing rib (274, 276, 278) is arranged in an internal region (242) of the carrier element (212).
42. A body unit, comprising a body component (210) that comprises an elongate carrier element (212) and at least one injection molded part (214), in particular comprising one or more features of one of the preceding embodiments, wherein the carrier element (212) has a through-hole or a plurality of through-holes (282), and wherein at least one injection molded part (214, 214′) engages in at least one through-hole (282).
43. The body unit according to the preceding embodiment, wherein, in the case of at least one through-hole (282), at least one injection molded part (214, 214′) engages all the way through this.
44. The body unit according to one of the two preceding embodiments, wherein, in the case of at least one through-hole (282), a portion of the at least one injection molded part (214, 214′) that engages in the through-hole (282) is arranged at a reinforcing rib (274, 276, 278) of the at least one injection molded part (214, 214′).
45. The body unit according to one of the three preceding embodiments, wherein, in the case of at least one through-hole (282), a reinforcing rib (274, 276, 278) of the at least one injection molded part (214, 214′) is formed such that it runs over a through-opening (284) of the through-hole (282), and in particular wherein a portion of the at least one injection molded part (214, 214′) that engages in the through-hole (282) is molded onto a portion of the reinforcing rib (274, 276, 278) that portion of the reinforcing rib runs over the through-opening (284).
46. The body unit according to one of the four preceding embodiments, wherein, in the case of at least one through-hole (282), the portion of the at least one injection molded part (214, 214′) that engages through the through-hole (282) is molded at its respective ends onto a reinforcing rib (274, 276, 278), in the region of a corresponding through-opening (284).
47. A body unit, comprising a body component (210) that comprises an elongate carrier element (212) and at least one injection molded part (214), in particular comprising one or more features of one of the preceding embodiments, wherein the carrier element (212) comprises a plurality of longitudinal portions (222, 224, 226), wherein at least two longitudinal portions (222, 224) extend longitudinally at least approximately parallel to one another and are at a spacing from one another transversely to their longitudinal extent, and at least in certain portions an internal region (242) of the carrier element (212) is defined between the at least two longitudinal portions (222, 224).
48. The body unit according to the preceding embodiment, wherein at least one further longitudinal portion (226) of the carrier element (212) connects the at least two mutually spaced longitudinal portions (222, 224) on one side of the internal region (242).
49. A body unit, comprising a body component (210) that comprises an elongate carrier element (212) and at least one injection molded part (214), in particular comprising one or more features of one of the preceding embodiments, wherein the carrier element (212) has a laterally open cross-sectional shape.
50. The body unit according to one of the preceding embodiments, wherein the carrier element (212) is made at least partly from a metallic material.
51. A body unit, comprising a body component (210) that comprises an elongate carrier element (212) and at least one injection molded part (214), in particular comprising one or more features of one of the preceding embodiments, wherein the carrier element (212) is at least partly formed from an injection molded part (214, 214′).
52. The body unit according to the preceding embodiment, wherein the carrier element (212) is formed entirely as an injection molded part.
53. The body unit according to one of the preceding embodiments, wherein the carrier element (212) is made at least partly from a material comprising a plastics material, in particular a high-strength plastics material.
54. The body unit according to one of the preceding embodiments, wherein the material of the carrier element (212) comprises at least two different materials, wherein in particular one of the at least two different materials has a greater elastic modulus than the other of the at least two different materials.
55. A body unit, comprising a body component (210) that comprises an elongate carrier element (212) and at least one injection molded part (214), in particular comprising one or more features of one of the preceding embodiments, wherein the carrier element (212) is at least partly fiber-reinforced.
56. The body unit according to the preceding embodiment, wherein the carrier element (212) is made from a fiber-reinforced material.
57. The body unit according to one of the two preceding embodiments, wherein the carrier element (212) is fiber-reinforced by a fiber-reinforced reinforcing component.
58. The body unit according to one of the three preceding embodiments, wherein the carrier element (212) is fiber-reinforced at least along a portion that, at least in respect of one operating mode, is on the driver's side.
59. The body unit according to one of the four preceding embodiments, wherein the carrier element (212) is fiber-reinforced at least approximately along its entire longitudinal extent.
60. A body unit, comprising a body component (210) that comprises an elongate carrier element (212) and at least one injection molded part (214), in particular comprising one or more features of one of the preceding embodiments, wherein at least one injection molded part (214, 214′) is at least partly fiber-reinforced.
61. The body unit according to one of the preceding embodiments, wherein embedded fibers form the fiber reinforcement.
62. The body unit according to one of the preceding embodiments, wherein the fiber reinforcement takes the form of a fiber-reinforced layer (712).
63. The body unit according to one of the preceding embodiments, wherein at least some of the fibers of the fiber reinforcement are entwined with one another.
64. The body unit according to one of the preceding embodiments, wherein at least some fibers of the fiber reinforcement are oriented at least approximately unidirectionally in at least one ply.
65. The body unit according to one of the preceding embodiments, wherein the fiber reinforcement comprises a plurality of plies having fibers.
66. The body unit according to one of the preceding embodiments, wherein the fibers of the fiber reinforcement comprise glass fibers and/or carbon fibers.
67. The body unit according to one of the preceding embodiments, wherein at least one injection molded part (214, 214′) is made in one piece.
68. The body unit according to one of the preceding embodiments, wherein at least one injection molded part (214, 214′) is made from plastics material.
69. A body (110) for a motor vehicle, comprising at least one body unit according to one of the preceding embodiments, and wherein in particular the body (110) comprises at least one further body component (210, 210′).
70. A motor vehicle having a body unit according to one of the preceding embodiments, in particular having a body (110) according to the preceding embodiment.
71. A method for the manufacture of a body unit comprising a body component (210, 210′), wherein the method comprises providing an elongate carrier element (212) and forming at least one injection molded part (214, 214′) for the body component (210, 210′), and wherein in particular the body component (210, 210′), in particular the carrier element (212) and/or at least one injection molded part (214, 214′), is provided with one or more features of one or more of the preceding embodiments.
72. The method according to the preceding embodiment, wherein a mold (610) is used for the manufacture of at least the body component (210, 210′), wherein the mold (610) comprises a plurality of mold units (612, 614) that are movable in relation to one another.
73. The method according to one of the two preceding embodiments, wherein an insert, in particular a carrier element (212) and/or a functional element (410, 410′), is inserted into a mold recess (622) of at least one mold unit (612, 614) before the injection molding, and wherein in the method at least one injection molded part (214, 214′) is molded onto the at least one insert, in particular at least a part of the insert being embedded in at least one injection molded part (214, 214′).
74. The method according to one of the three preceding embodiments, wherein the mold (610) comprises at least one mold unit (612, 614) that has a mold slide (628) that is displaceable relative to a mold unit base (626).
75. The method according to one of the four preceding embodiments, wherein the formation of at least one injection molded part comprises multi-component injection molding.
76. A method for the manufacture of a body (110), in particular for the manufacture of a vehicle having a body (110), wherein at least one body unit is manufactured in accordance with a method according to one of the five preceding embodiments.

Further preferred features and embodiments and advantages of the invention form the subject matter of the description below of an exemplary embodiment and the representation in the drawing.

### BRIEF DESCRIPTION OF THE DRAWINGS

In the drawing:

FIG. 1 shows a body of a vehicle;

FIG. 2 shows a perspective illustration of a body component of the body, in a view of a side facing a driver-control region;

FIG. 3 shows an exploded illustration of a carrier element and, molded onto this, an injection molded part of the body component, in a view similar to FIG. 2;

FIG. 4 shows a perspective illustration of the body component, in a view of a side facing a front region;

FIG. 5 shows an exploded illustration of the carrier element and the injection molded part, in a view similar to FIG. 4;

FIG. 6 shows an enlarged illustration of the body component in the region of a longitudinal end with a flange body;

FIG. 7 shows a sectional illustration through the carrier element and the injection molded part along the section VII-VII that is marked in FIG. 6;

FIG. 8 shows an enlarged illustration of a detail of the body component in the region of the functional element;

FIG. 9 shows a sectional illustration through the functional element, the injection molded part and the carrier element along the section IX-IX that is marked in FIG. 8;

FIG. 10 shows an enlarged illustration of a holding part of the functional element;

FIG. 11 shows a sectional illustration of the holding part embedded in a holding body of the injection molded part;

FIG. 12 to FIG. 15 show a sequence of a method movement of mold units of a mold, in a method for the formation of the injection molded part, and the injection molded part that is formed during this;

FIG. 16 shows an illustration, similar to FIG. 9, of a second exemplary embodiment of a body component;

FIG. 17 shows an illustration of a body component in a variant of the exemplary embodiments; and

FIG. 18 shows a schematic illustration of a fiber-reinforced carrier element of a further variant of the exemplary embodiments.

### DETAILED DESCRIPTION OF THE INVENTION

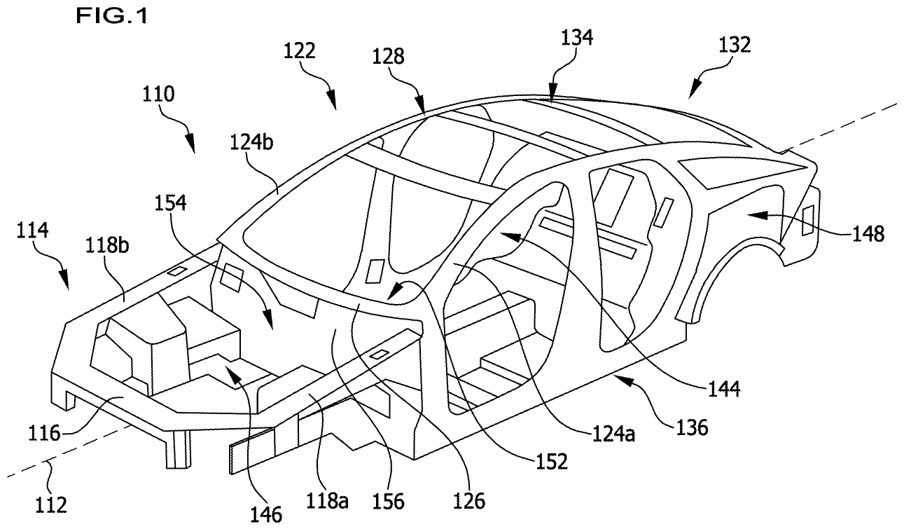

An exemplary embodiment of a body, which is designated 110 as a whole, of a motor vehicle (not illustrated in detail in the drawings), and which is illustrated by way of example in FIG. 1, comprises a plurality of body components, which are in particular bracing parts for the body skeleton, casing parts, and for example built-on parts.

The body skeleton comprises, in particular in a forward region 114 as seen in relation to a vehicle longitudinal axis 112, a forward transverse support 116 on which are laterally arranged two longitudinal supports 118a and 118b that extend as far as a central region 122 and are connected to a respective corresponding A pillar support 124a and 124b.

Preferably, provided in the central region 122, at the front as seen in relation to the vehicle longitudinal axis 112, is a windshield transverse support 126 that extends transversely to the vehicle longitudinal axis 112, and provided in an upper region is a roof support structure that in particular comprises transverse supports and longitudinal supports and that extends above the central region 122. The A pillar supports 124a and 124b are arranged laterally in the central region and connected to the windshield transverse support 126 and the roof support structure.

Arranged in a rear region 132 at the back is a rear support structure 134 that in particular likewise comprises transverse supports and longitudinal supports and is connected to the roof support structure.

In particular, the body 110 also comprises a body substructure 136 that is arranged below the roof support structure 128 and is connected, directly or indirectly by way of carrier elements, to the longitudinal supports 118, the pillar supports 124a, b and the rear support structure 134.

An oriented vehicle longitudinal direction 138 is oriented along the vehicle longitudinal axis 112 from the rear region 132 forward to the forward region 114 such that, as seen in the vehicle longitudinal direction 138, the forward region 114 is at the front and the rear region 132 is at the back. In particular, the vehicle longitudinal direction 138 corresponds substantially to a direction of travel of the vehicle during straight-ahead travel.

In the text above and below, the wording “top” and “bottom” is used in relation to a normal orientation of the body and the vehicle, in particular when the latter stands on a horizontal surface, and to a vertical line through the vehicle longitudinal axis 112, so that the roof support structure 128 is arranged at the top and the body substructure 136 is arranged on the bottom of the body, and when the vehicle is standing on the horizontal surface the road surface is below the body substructure 136.

The body 110 defines an internal space 142 in which, in the central region 122, the passenger compartment is provided, and in particular an engine compartment 146 is arranged in the forward region 114 and a trunk 148 of the vehicle is arranged in the rear region 132, provided the vehicle has a front drive, and in variants in which the vehicle has a rear drive an engine compartment is arranged in the rear region 132 and for example a trunk 148 is arranged in the forward region 114.

In particular, the internal space 142 comprises a driver-control region 152 and a front region 154, which in relation to the vehicle longitudinal axis 112 and as seen in the vehicle longitudinal direction 138 is arranged in front of the driver-control region 152, wherein in particular the driver-control region 152 is at least a partial region of the passenger compartment 144 and for example the front region 154 is at least a partial region of the engine compartment 146 in the case of a vehicle with front drive, and in variants of the vehicle with rear drive it is for example a partial region of the trunk.

In particular, the driver-control region 152, and preferably the entire passenger compartment, is arranged between the roof support structure 128 and the body substructure 136, in relation to a direction.

In particular, the windshield transverse support 126 is arranged in front of the driver-control region, as seen in the vehicle longitudinal direction 138.

Preferably, the body 110 comprises a front wall 156 that is arranged between the driver-control region 152 and the front region 154 and in particular is secured to the longitudinal supports 118a, b, the A pillar supports 124a, b and the body substructure 136.

In particular, the internal space 142 extends in the at least substantially vertical direction between the roof support structure 128 and the body substructure 136, and as seen in the vehicle longitudinal direction 138 between the forward transverse support 116 and a rearward region of the rear support structure 134.

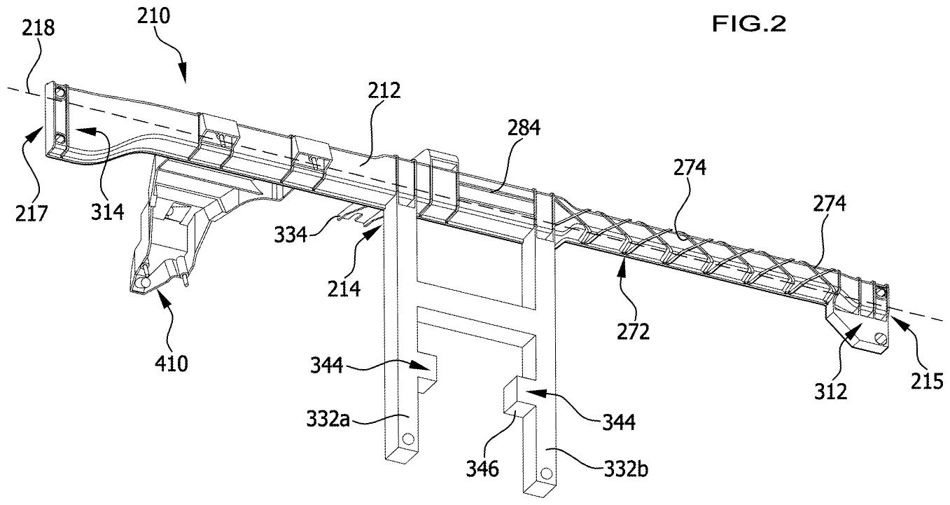

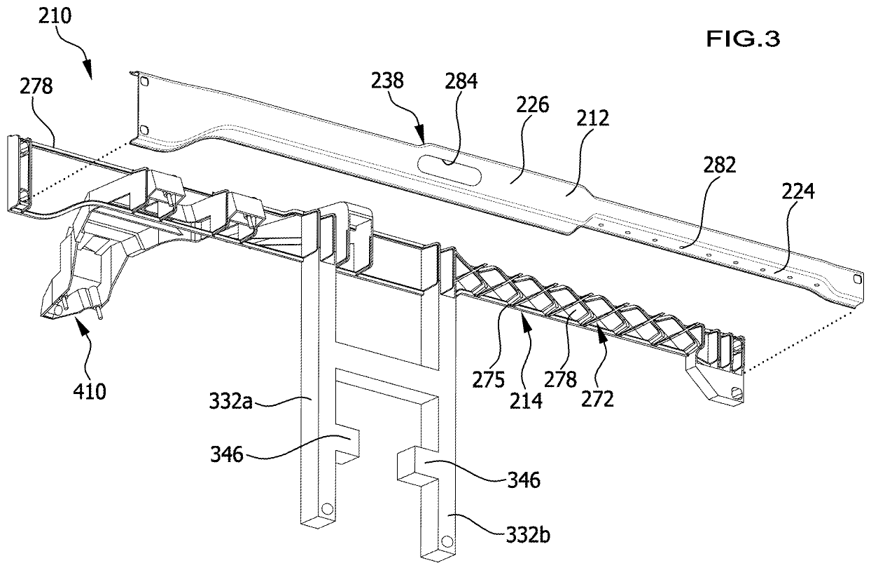

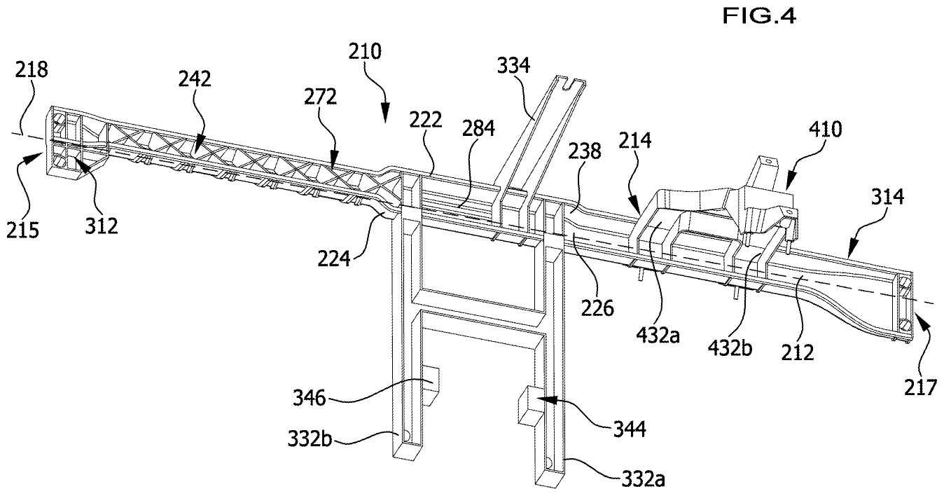

A body component 210, which is illustrated by way of example in FIGS. 2 to 11, comprises an elongate carrier element 212 and at least one injection molded part 214 that is preferably molded onto the carrier element 212.

In this exemplary embodiment, the body component 210 extends between the A pillar supports 124a, b and is secured to these and to a body substructure 136.

In particular, the body component 210 is provided for securing vehicle functional units such as a steering column, and for example for securing control units, by means of which a driver of the vehicle can control the vehicle and for example units of its equipment such as an air conditioning system and/or an audio system and/or a navigation system.

In variants of the exemplary embodiment, the body component 210 may also have additional and/or alternative functions and/or may be arranged in a different region of the body and be secured to different body components.

The body component 210 extends in a substantially elongate manner along a component axis 218, wherein individual components thereof such as the injection molded part 214 extend transversely to the component axis 218, away from the substantially elongate underlying structure of the body component 210.

The component axis 218 is defined substantially by the carrier element 212, which extends substantially along the component axis 218 in a longitudinal extent.

For example, the carrier element 212 is a metallic carrier element.

The carrier element 212 comprises a plurality of longitudinal portions 222, 224, 226 that extend along the component axis 218 at least between two longitudinal ends 215 and 217 of the body component 210, which are opposite one another along the component axis 218.

Preferably, the longitudinal portions 222, 224, 226 take a substantially planar form along their longitudinal extent, for example taking a planar form throughout or taking a planar form along the majority of the longitudinal extent.

For example, individual step portions or a step portion 238 between planar portions are provided. In particular, a longitudinal extent of the step portion 238 is substantially smaller than the longitudinal extent of the longitudinal portion.

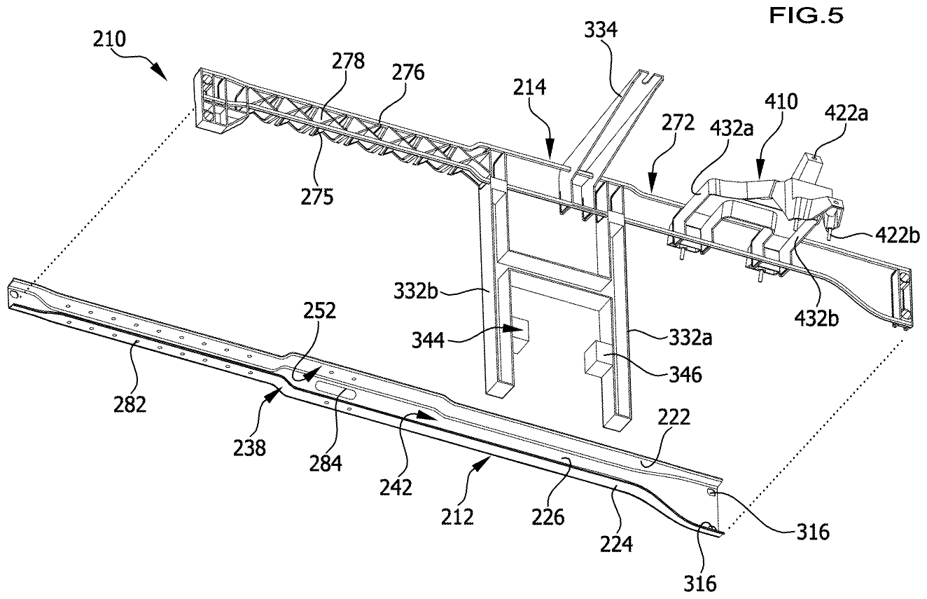

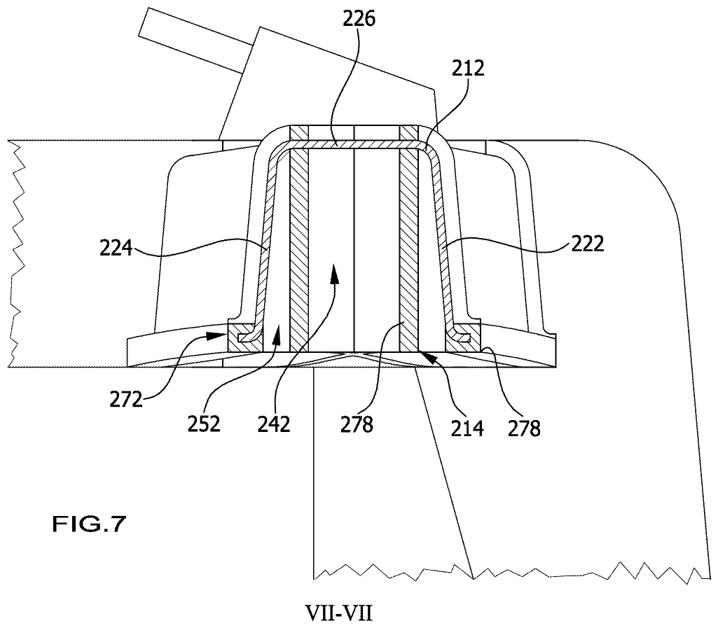

Preferably, transversely to its longitudinal extent, in particular in relation to a cross section running at least approximately perpendicular to the component axis 218, the carrier element 212 has an open cross-sectional profile, in particular a C-shaped profile, as illustrated by way of example in FIGS. 5 and 7.

Two longitudinal portions, in this case the longitudinal portions 222 and 224, run substantially parallel to one another and are at a spacing from one another transversely to the axial direction of the component axis 218 such that corresponding inner flat sides thereof face one another and partly delimit a hollow internal region 242 of the carrier element 212.

A further longitudinal portion, in this case the longitudinal portion 226, connects the two mutually spaced longitudinal portions 222, 224 and is in each case molded onto these, for example in a respective curved region 246, 248, and delimits the internal region 242 transversely to the component axis 218 and transversely to the direction in which the two spaced longitudinal portions 222 and 224 delimit the internal region 242.

Thus, the internal region 242 is open toward one side 252, wherein the open side 252 is arranged opposite the connecting longitudinal portion 226 and is delimited by the spaced longitudinal portions 222 and 224.

The in particular one-piece injection molded part 214 has a reinforcing component 272 that is molded directly onto the carrier element 212 and reinforces it.

The reinforcing component 272 comprises a multiplicity of reinforcing ribs 274, 276, 278.

Preferably, some of the reinforcing ribs, in this case the reinforcing ribs 274, run along the outer side of the carrier element 212, peripherally along it and for example transversely and/or at least approximately perpendicular to the component axis 218, and in so doing preferably run through all the longitudinal portions 222, 224, 226, for example from one margin of the open side 252 along the periphery of the carrier element 212 to the other margin of the open side 252.

In particular, some of the reinforcing ribs, in this case the reinforcing ribs 276, run longitudinally, that is to say in particular at least approximately parallel to the component axis 218, along a margin of the open side 252, and in so doing are preferably connected to the peripheral reinforcing ribs 274 at contact locations 275.

It is particularly favorable if some of the reinforcing ribs, in this case the reinforcing ribs 278, are arranged in the internal region 242 of the carrier element 212. In particular, some of these reinforcing ribs 278 extend transversely and cross one another, wherein some of the reinforcing ribs 278 are formed to extend at least approximately parallel to the component axis 218, some of the reinforcing ribs 278 are formed to extend at least approximately perpendicular to the component axis 218, and some of the reinforcing ribs 278 are formed to extend obliquely to the component axis 218.

For example, in the case of at least some of the peripheral reinforcing ribs 274, there are arranged corresponding inside reinforcing ribs 278, which run on the inside along the part of the carrier element 212 that is embraced by the outer reinforcing rib 274.

Some of the reinforcing ribs, in this case in particular the peripheral reinforcing ribs 274 and marginal reinforcing ribs 276, take a linear form, wherein other reinforcing ribs, in this case in particular the inside reinforcing ribs 278, take a planar form.

In particular, the linear reinforcing ribs have a cross section transverse to their longitudinal extent of which the dimension is at least approximately of the same size in mutually perpendicular directions.

In the case of planar reinforcing ribs, their cross section transverse to their longitudinal extent has a dimension in one direction that is substantially greater than, for example being at least five times the size, in particular at least ten times the size, a dimension in a direction at least approximately perpendicular to the one direction.

For example, at least some of the inside reinforcing ribs 278 extend in planar manner from the open side 252 as far as the longitudinal portion 226 that lies opposite the open side 252, and transversely thereto from one of the spaced longitudinal portions 222, 224 to the other of the two spaced longitudinal portions 224, 222.

Preferably, the carrier element 212 has small through-holes 282 along its longitudinal portions 222, 224, 226, wherein the reinforcing component 272 of the injection molded part 214 engages through the through-holes 282 by means of pin elements, wherein at their respective ends the pin elements are preferably molded onto an outside reinforcing rib, in this case for example the peripheral reinforcing ribs 274, and are molded on the inside onto the inside reinforcing ribs 278.

In particular, at least some of the reinforcing ribs extend at least between two through-holes 282.

Preferably, at least some of the outside reinforcing ribs 274 run from a through-hole 282 in one of the spaced longitudinal portions 222, 224 along the periphery of the carrier element 212, at least as far as a through-hole in the other of the spaced longitudinal portions 224, 222.

For example, at least some of the inside reinforcing ribs 278 extend at least between two through-holes 282 in for example the two spaced longitudinal portions 222, 224.

For example, at least one longitudinal portion, in this case the connecting longitudinal portion 224, has openings 284 that are bordered and reinforced by portions of the reinforcing component 272 that border the opening.

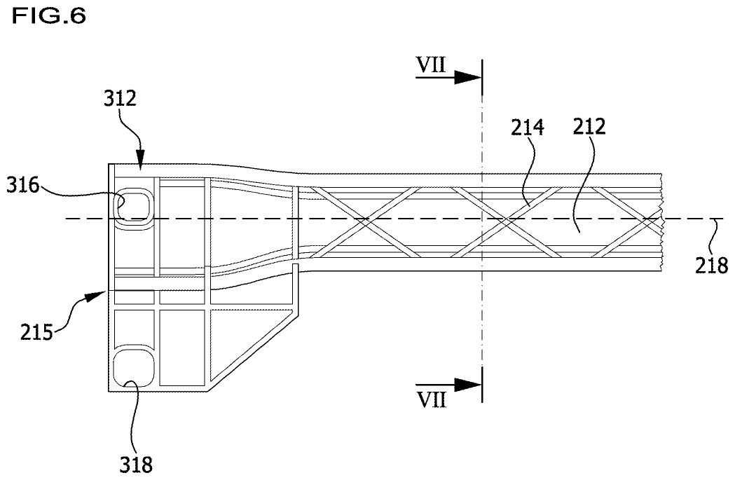

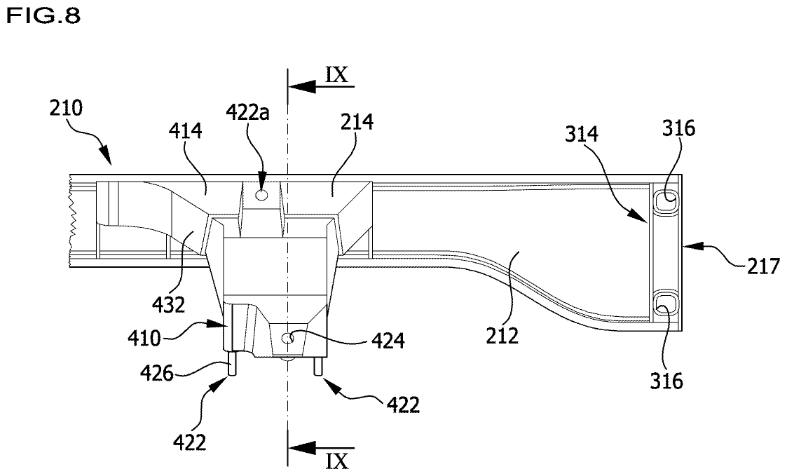

At its longitudinal ends 215 and 217, the body component 210 has respective flange bodies 312 and 314 that are formed by the carrier element 212 and the injection molded part 214, for the purpose of securing to further components of the body, as illustrated for example in FIGS. 6 and 8.

In particular, the flange bodies 312, 314 have securing apertures 316, 318, wherein for example at least one securing aperture, in this case the securing aperture 316, is formed in the carrier element 212 and reinforced by corresponding portions of the injection molded part 214, and in particular at least one securing aperture, in this case the securing aperture 318, is formed solely by the injection molded part 214.

Preferably, the body component 210 has further securing components, in this case securing struts 332, 334, which are formed by the injection molded part 214 and extend transversely to the component axis 218, in an elongate manner away from the elongate underlying structure with the carrier element 212, as illustrated by way of example in FIGS. 2 to 5.

For example, two securing struts 332a, b are provided that extend away downward and have at their respective lower ends, which are spaced from the carrier element 212, securing locations, for example having securing apertures, for the purpose of being secured for example to the body substructure 136.

Preferably, the securing struts 332 have one or more mounting locations 344 that are at least partly formed by flange portions 346 that face the driver-control region 152 and on which equipment units and/or control elements may be arranged, and in the assembled condition of the vehicle are arranged, for operation by the driver.

Preferably, at least one securing strut, in this case the securing strut 334, extends transversely to the component axis 218, forward as seen in the direction of the vehicle longitudinal direction 138, into the front region 154, and is provided with securing locations for the purpose of being secured to a further component of the body and/or with at least one mounting location at which vehicle functional units, for example an engine unit, and/or units for equipment, for example an air conditioning system, may be arranged and held, and in the assembled condition are arranged and held, at least partly by the securing strut 334.

Additionally provided is a functional element 410, which is held at a holding part 412 thereof by a holding component 414 of the injection molded part 214, as illustrated in particular by way of example in FIGS. 8 to 11.

In this exemplary embodiment, the functional element 410 is a securing element by means of which the body component 210 may be secured, and in the assembled condition is secured, to a further component of the body, in this case the front wall 156.

In variants of the embodiment, the functional element 410 is for example an element of a vehicle functional unit or an equipment unit.

For the purpose of securing to at least one further body component, the functional element 410 comprises a plurality of securing parts 422, wherein in particular some securing parts 422a have stably formed securing receptacles 424 for receiving securing elements such as bolts and/or screws, and further securing parts 422b have securing elements 426 such as bolts, or in the case of variants also screws, for connection to for example securing receptacles in other body components.

In this exemplary embodiment, the functional element 410, which takes the form of a securing element, is secured to the front wall 156, and thus when the body is assembled is positioned in front of the carrier element 212, as seen in the vehicle longitudinal direction 138, and is arranged on a side of the body component 210 that is remote from the driver-control region 152.

The functional element 410, which comprise the holding part 412 and the functional parts 422 taking the form of securing parts, in this exemplary embodiment is formed in one piece and is made from a metallic material, in particular magnesium.

With its side having its holding part 412, the functional element 410 faces the carrier element 212, and the holding component 414 comprises two holding arms 432a and 432b that are molded onto the reinforcing component 272 and extend away from the carrier element 212 transversely, in particular at least approximately perpendicular, to the component axis 218, and are molded onto a holding body 434 of the holding component 414, wherein the holding body 434 is connected to the holding part 412 in a manner holding the latter.

In particular, the holding part 412 is embedded in the holding body 434.

In particular, the holding body 434 covers large areas of the holding part 412.

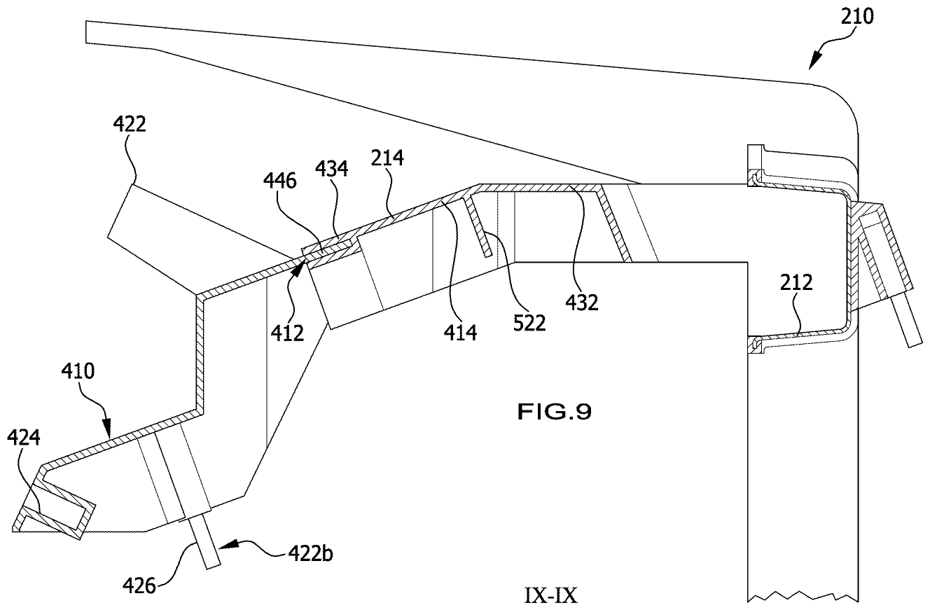

The holding part 412 comprises in particular three flange portions 442, 444, 446 that delimit a receiving space 448 on three sides, as illustrated by way of example in FIGS. 9 to 11.

In particular, the flange portions 442, 444, 446 are flat flange portions with large surface areas and mutually opposing flat sides, wherein in each case one of the flat sides delimits the receiving space 448.

In this case, two flange portions 442 and 444 run at a spacing from one another, as lateral outer walls of the receiving space 448, and are connected to one another by the third flange portion 446, wherein the connecting flange portion 446 is molded at opposing ends thereof onto a respective one of the spaced flange portions 442 and 444.

For example in this context, the one flange portion, in this case the flange portion 442, is surrounded on both sides—on the side facing the receiving space 448 and the opposite side—over its full surface and at least substantially entirely by the holding body 434 and is embedded therein, and the other of the spaced flange portions, in this case the flange portion 444, is at least partly embedded in the holding body 434.

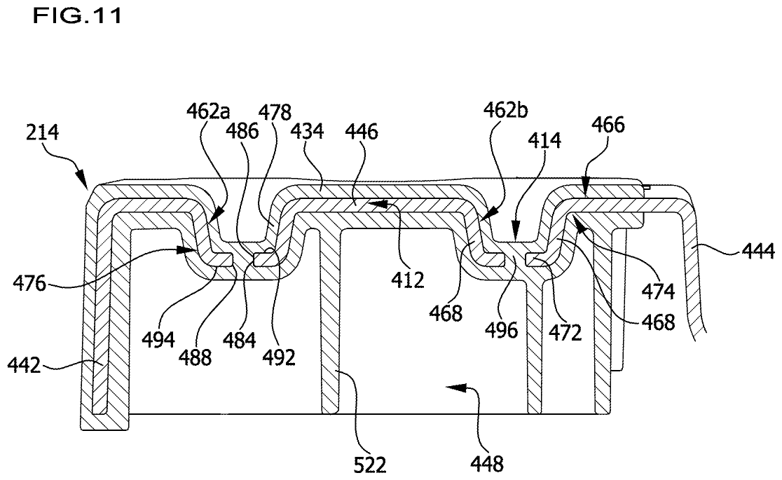

The connecting flange portion 446 is also embedded in the holding body 434 on both sides to a very large extent, wherein FIG. 11 illustrates by way of example a region in which a molding-on region in which the flange portion 446 is molded onto the flange portion 444 is free of material of the holding component, and wherein otherwise the connecting flange portion 446 is surrounded over its full surface by the holding body 434.

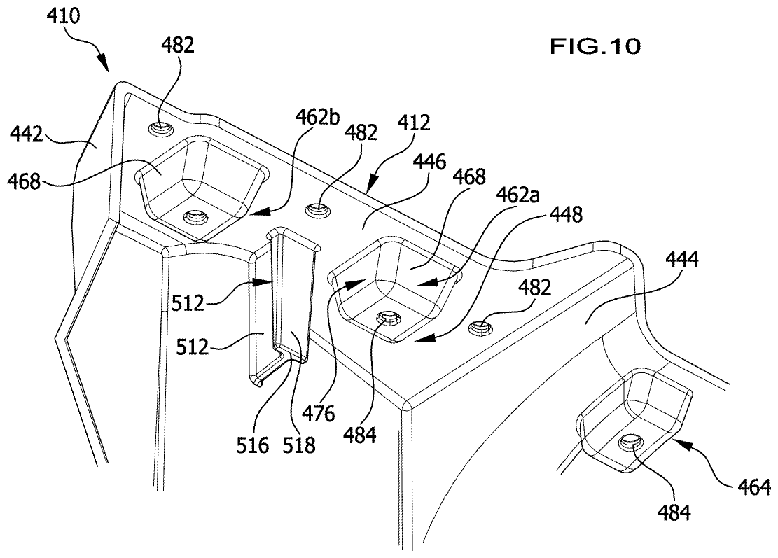

The holding part 412 comprises a plurality of recessed elements 462, 464, wherein for example two recessed elements 462a and 462b are shaped in a flange portion, in this case the connecting flange portion 446, and a further recessed element 464 is shaped in a further portion of the holding part 412, as illustrated by way of example in FIGS. 10 and 11.

The recessed elements 462, 464 in this case take substantially the same form, so they are explained together.

The recessed element 462, 464 extends from a starting side 466 toward which the recessed element 462, 464 is also open, into the holding part 412 with wall portions, which in this case form an inner wall 468 of the recessed element 462, and as far as a base portion 472, which in this case projects beyond the side 474 opposite the starting side 466, such that the recessed element 462, 464 forms a projection 476 on the opposite side 474, as illustrated by way of example in FIGS. 10 and 11.

Here, the recessed elements 462 shaped in the flange portion 464 project into the receiving space 448, and the opposite side 474 is in this case a side of the flange portion 464 that delimits the receiving space 448.

Here, the holding body 434 of the holding component 414 is molded onto the recessed elements 462, 464 such that it has an engaging portion 478 that engages in the recessed element 462, 464 and in so doing entirely covers the inner wall 468 thereof and also the base portion.

In particular, the recessed element 462, 464 is embedded on both sides in the holding body 434 such that the part that projects on the opposite side 474 and forms the projection 446 is also entirely surrounded by the holding body 434.

Moreover, the holding part 412 has a multiplicity of apertures 482, 484, wherein a first group of apertures 482 is made in a flange portion, in this case the flange portion 446, and a second group of apertures 484 is made in the recessed elements 462, 464, in particular in the base portion 472 thereof, as illustrated by way of example in FIGS. 10 and 11.

The apertures 482, 484 take substantially the same form, so they are explained here together.

In each case, the aperture 482, 484 opens on the opposing sides by means of a through-opening 486, 488, and extends continuously between the through-openings 486, 488, all the way through the holding part 412. Here, each of the through-openings 486 and 488 is bordered by a border portion 492 or 494 of the holding part 412.

By means of a filling portion 496, in this case taking for example a pin-shaped form, the holding body 434 entirely fills the aperture 482, 484, and portions that are molded onto the filling portion 496 entirely cover the border portions 492 and 494 such that the aperture 482, 484 and a region of the holding part 412 surrounding it are entirely embedded in the holding body 434.

Moreover, the holding part 412 has a holding rib 512 or a plurality of holding ribs 512 that are arranged in particular in the receiving space 448.

The holding ribs 412 are in this case formed from rib portions 514, 516 that run transversely to one another and are in particular molded onto a flange portion, in this case the flange portion 446, and extend away from this, wherein one of the rib portions, in this case the rib portion 514, takes a form running transversely to the component axis 218, and a further rib portion, in this case the rib portion 516, takes a form running substantially parallel to the component axis 518 and for example faces the carrier element 212 by means of an end-face side 518.

Preferably, the holding body 434 at least partly embeds the holding ribs 512 as well, and in particular embraces at least one rib portion, in this case the rib portion 516, on its end-face side 518 that faces the carrier element 212 and on the side remote from the carrier element 212.

In particular, the holding body 434 also has bracing ribs 522 that reinforce it and for example at least partly take the form of prolonged parts of portions surrounding the holding ribs 512, as illustrated by way of example in FIGS. 9 and 11.

In this case, preferably the holding part 412 has a plurality of undercuts, in particular on the holding ribs 512 with their transversely running rib portions 514, 516 and/or on the recessed elements 462, 464 and/or at the apertures 482, 484, wherein the undercuts are in some cases undercuts in the direction that is drawn from the carrier element 212 in the direction towards the functional element 410 and corresponds at least approximately to the vehicle longitudinal direction 138, and in some cases undercuts drawn transversely to this direction, in particular drawn in an axial direction of the component axis 218.

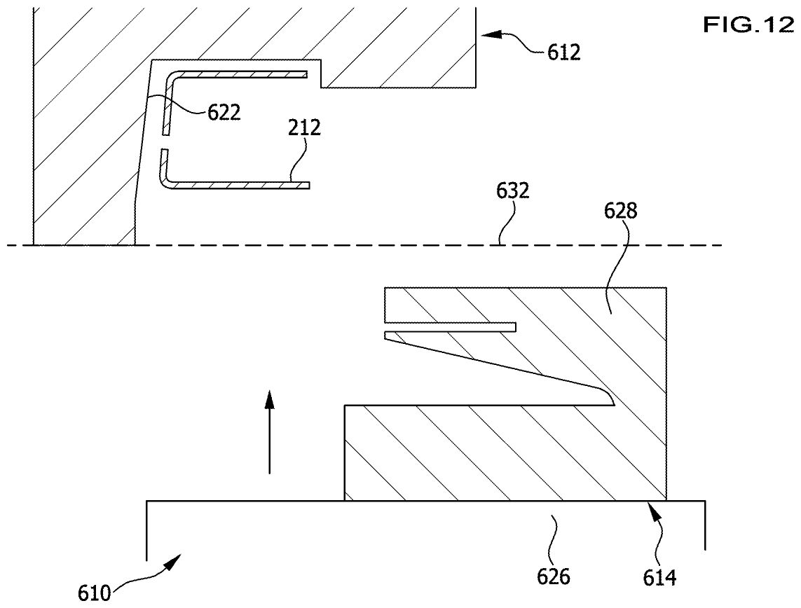

In particular, the body component 210 is provided with a mold, which is designated 610 as a whole and has the at least one injection molded part 210, as illustrated by way of example in the sequence of FIGS. 12 to 15. In this arrangement, the mold 610 has a plurality of mold units, in this case for example at least the mold units 612 and 614, of which at least some are displaceable in relation to one another.

Here, the mold units 612, 614 have mold recesses which, in particular when put together, substantially form the shape of the at least one injection molded part 214 and where appropriate further injection molded parts.

In the method, before injection molding, inserts are inserted into at least some mold recesses, for example the mold recess 622 of the mold unit 612, and these inserts form elements and/or components of the body component 210, such as the metallic carrier element 212 and/or the in particular metallic functional element 410, as illustrated by way of example in FIG. 12.

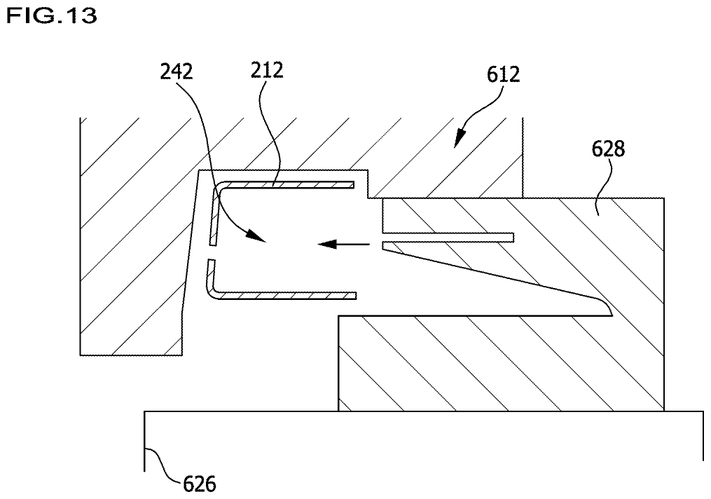

Once the inserts have been inserted into their corresponding mold recesses, the mold units, which are movable relative to one another, are moved into position relative to one another such that the inserts are arranged in relation to one another in the relative positions provided for the body component 210, illustrated by way of example in FIG. 13.

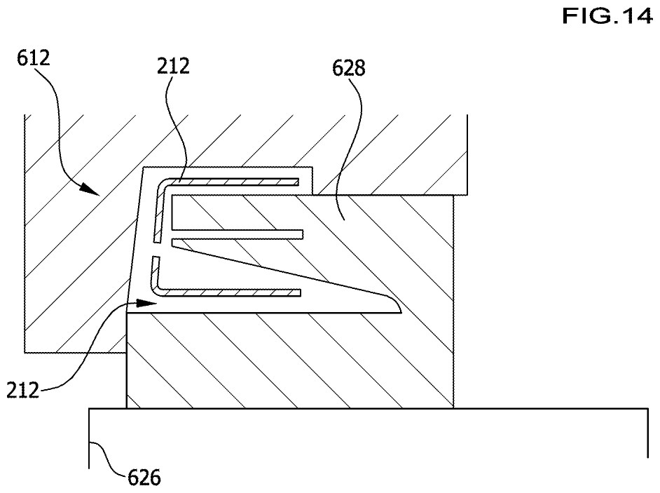

Furthermore, at least one mold unit, in this case the mold unit 614, has a mold slide 628 which is displaceable in relation to a mold unit base 626 and by means of which complex shapes of the injection molded part 214 and in particular undercuts therein and/or recesses therein can be shaped in inserts, illustrated by way of example in FIGS. 13 and 14.

Once the inserts, such as the carrier element 212, have been inserted into the corresponding recesses 622 for example in the mold unit 612, the mold units 612 and 614 are moved in relation to one another, and the one mold unit 614 is moved at least approximately perpendicular to a mold plane 632 toward the other mold unit 612, as far as an end position (FIG. 12). In this end position, illustrated by way of example in FIG. 13, the mold slide 628 is then moved relative to the mold unit base 626 into an end position, wherein in this case for example parts of the mold slide 628 engage in the internal region 242 of the carrier element 212 and hence provide mold portions for the injection molded part therein, illustrated by way of example in FIG. 14.

Then, the injection molding material is injected such that the molding cavity formed by the mold units is filled.

After the injection phase and an at least partial cooling of the injection molded part, the mold units are moved back into their home position for demolding, wherein in particular the mold slide 628 is moved first out of its end position and into a home position.

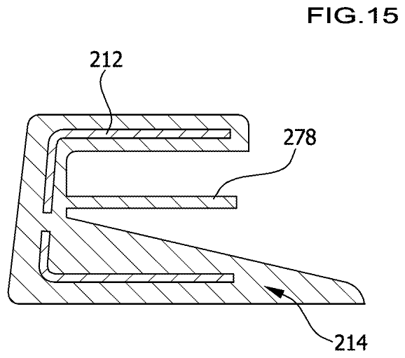

By way of example, FIG. 15 illustrates the structure of the injection molded part 214 that is molded onto the carrier element 212 in this way.

In this way, as illustrated and described by way of example for the carrier element 212 as an insert, the injection molded part may also be molded onto other inserts, in particular the functional element, and/or provided with inserts, in particular stabilizing securing parts, and given the form of complex structures.

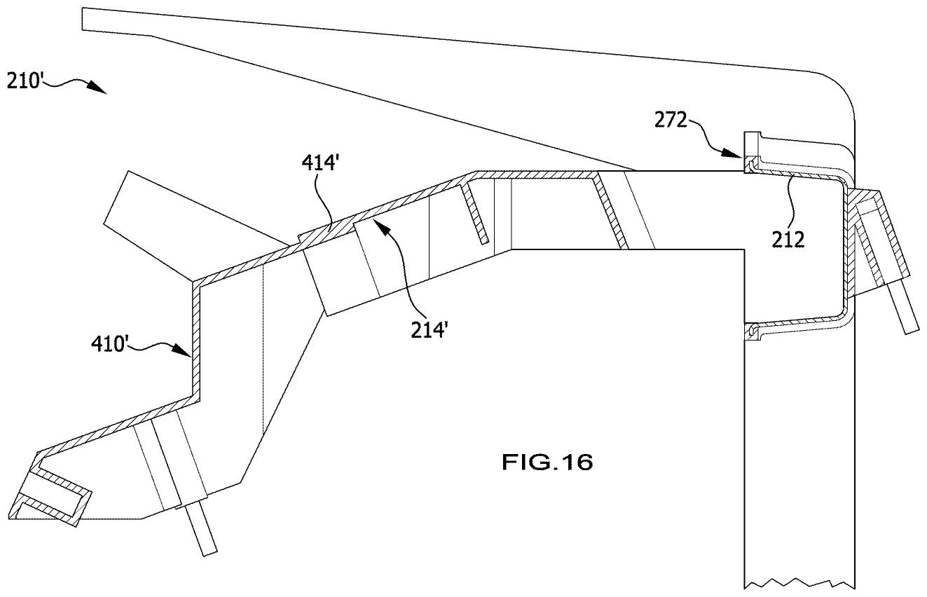

In a second exemplary embodiment of a body component, which is designated 210′ as a whole and is illustrated by way of example in FIG. 16, the elements and features that take at least basically the same form and/or that fulfill substantially the same function are provided with the same reference numeral as above, and where no statements to the contrary are made below, these are formed as above. In particular, if a particular form taken in the case of this exemplary embodiment is to be pointed out explicitly, the reference numeral is provided with a prime mark.

In this exemplary embodiment, a functional element 410′ takes the form of an injection molded part 214′.

In particular, the injection molded part 214′ also has a holding component 414′ which, in this exemplary embodiment, is made in one piece with the functional element 410′, and by means of which the functional element 410′ is arranged on the carrier element 212.

Preferably, otherwise the body component 210′, in particular the injection molded part 214′ and the carrier element 212, take at least substantially the form of the first exemplary embodiment.

Thus, in particular the injection molded part 214′ likewise has a reinforcing component 272 for reinforcing the carrier element 212. For advantageous configurations, reference is made to the statements above in connection with the first exemplary embodiment.

The functional element 410′ comprises in particular functional parts that are formed for example by the injection molded part 214′ and/or are individual, separate parts which, in particular in the context of the injection molding method, are connected to the injection molded part 214′ as inserts. Otherwise, as regards the function and functional parts of the functional element 410′, reference is made to the statements in connection with the first exemplary embodiment.

The holding component 414′ is formed in particular in one piece with the functional element 410′ and the reinforcing component 272. For example, it also has reinforcing ribs and/or bracing ribs.

Otherwise, the body component 210′ of the second exemplary embodiment, with its elements and features, at least substantially takes the same form as the body component of the first exemplary embodiment, so in order to avoid repetition reference is made to the statements in connection with the first exemplary embodiment in their entirety.

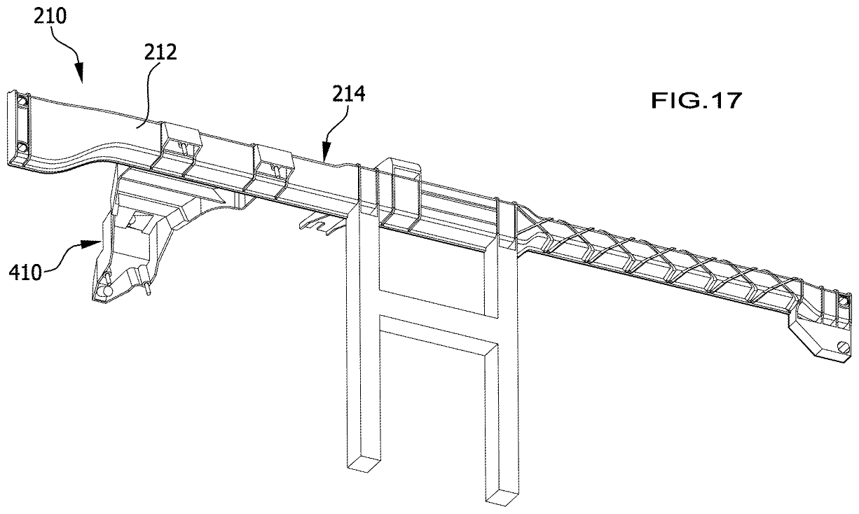

In the case of variants of the first and/or second exemplary embodiment, the carrier element 212 is made partly or entirely from the injection molded part 214, 214′, as illustrated by way of example in FIG. 17.

In particular in the case of these variants, the part forming the carrier element 212, and the holding component of the injection molded part 214, 214′ are made in one piece.

Preferably in these variants, the injection molded part 214, 214′ has features as explained in connection with the reinforcing component, in particular reinforcing ribs.

Further configurations of the body component, in particular the carrier element and/or the components of the injection molded part, also preferably take the same form as in one of the exemplary embodiments explained above, so reference is made to the above statements in this regard, and in this variant the only difference is that the injection molded part at least partly forms the carrier element.

In particular, in these variants the body component 210, 210′ is thus substantially formed as an injection molded part.

In some variations, the injection molded part is made from a plastics material, for example a high-strength plastics material.

In other variations, the injection molded part 214, 214′ is made from a plurality of plastics materials, wherein the injection molded part is made by a multi-component injection molding method, and thus for example locations on the injection molded part that are under particularly heavy load, such as at least portions of the carrier element, for example at least the portion on the driver's side, are made using a high-strength plastics material and locations that are under less load, such as portions for securing equipment units, are made using a lower-cost plastics material.

The rest of the construction in the case of these variants is correspondingly as explained above in connection with the first and second exemplary embodiments, so reference is made to these statements in their entirety.

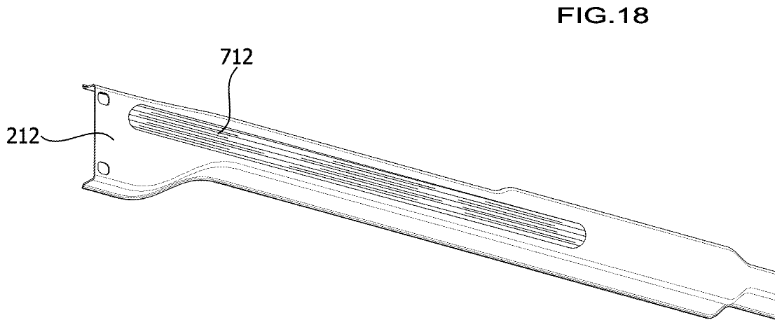

In further variants of the first or second exemplary embodiment, which are illustrated by way of example in FIG. 18, at least one element and/or component of the body component 210, 210′ is formed to be fiber-reinforced.

In particular, the carrier element 212 and the injection molded part 214, 214′ are formed to be fiber-reinforced.

In some of these variants, the fiber reinforcement is formed such that the corresponding element and/or component, in particular the carrier element 212 and/or the injection molded part 214, 214′, in particular its holding component 414, 414′ and/or its reinforcing component 272, and/or the functional element 410, 410′, is/are in particular formed by a fiber-reinforced material, in particular a fiber-reinforced composite material.

In other variants, the fiber reinforcement of the corresponding element and/or component, in particular as listed above, is/are formed by a fiber-reinforced layer 712, as illustrated by way of example in FIG. 18.

In this case, the fiber-reinforced layer 712 comprises fibers that are embedded in a material, preferably a thermoplastic material.

The layer 712 is then arranged on the corresponding component and/or element and secured thereto such that the latter is fiber-reinforced.

For example, the carrier element 212 is fiber-reinforced at least in certain portions, in particular along a portion that is provided on a driver's side, or is fiber-reinforced at least approximately along the entire longitudinal extent. In this case, this fiber reinforcement may be made both by the fiber-reinforced material and also by the layer that extends along the corresponding portion or the longitudinal extent.

Preferably in this case, the fibers are arranged in plies. In particular, the fibers are arranged partly unidirectionally and partly intertwined into a braided arrangement in order to have a reinforcing effect preferably along load paths.

Correspondingly, in the case of the variants the injection molded part 214, 214′, in particular its holding component and/or its reinforcing component, is also fiber-reinforced.

For example, in this case the layer is provided as an insert in an injection molding method.

The functional element 410, 410′ is also correspondingly fiber-reinforced in some of these variants.

Otherwise, these variants take at least substantially the same form as the above-explained exemplary embodiments and their variants, so reference is made to the statements above in their entirety.

In particular, the features and configurations of the different exemplary embodiments and variants thereof are substantially combinable with one another.

1. A body unit, comprising a body component that comprises an elongate carrier element and at least one injection molded part, the at least one injection molded part is molded at least partly onto the carrier element and holds at least one functional element at a holding part of the functional element.

2. The body unit as claimed in claim 1, wherein the holding part comprises at least one flange portion at which the injection molded part holds the functional element.

3. The body unit as claimed in claim 1, wherein the holding part has at least one undercut and the injection molded part embraces at least one undercut.

4. The body unit as claimed in claim 3, wherein at least one undercut is an undercut in relation related to a direction oriented from the holding part toward the carrier element.

5. The body unit as claimed in claim 1, wherein the holding part has at least one wall portion that runs at least approximately parallel to a longitudinal extent of the carrier element, and at least one portion of the injection molded part at least partly, covers at least a side of the wall portion remote from the carrier element.

6. The body unit as claimed in claim 1, wherein the holding part has at least one recessed element and the injection molded part engages in the at least one recessed element with an engaging portion.

7. The body unit as claimed in claim 1, wherein the holding part has at least one aperture and the injection molded part engages through the least one aperture.

8. The body unit as claimed in claim 1, wherein the holding part comprises at least one holding rib and the injection molded part embraces the at least one holding rib.

9. The body unit as claimed in claim 1, wherein the holding part has at least one receiving space in which the injection molded part engages.

10. The body unit as claimed in claim 9, wherein at least one portion of the holding part that delimits the receiving space has at least one aperture.

11. The body unit as claimed in claim 9, wherein at least one holding rib is arranged in the at least one receiving space.

12. A body unit, comprising a body component that comprises an elongate carrier element and at least one injection molded part, the at least one injection molded part is molded at least partly onto the carrier element and forms at least one functional element.

13. The body unit as claimed in claim 12, wherein the functional element takes the form of a securing element for securing a vehicle functional unit.

14. The body unit as claimed in claim 12, wherein the functional element takes the form of a securing element for being secured to a further body component.

15. The body unit as claimed in claim 12, wherein the body unit comprises at least one further body component, and in that the at least one further body component is secured to the functional element.

16. The body unit as claimed in claim 1, wherein the at least one functional element is at least partly made from metal.

17. The body unit as claimed in claim 12, wherein the functional element is at least partly fiber-reinforced.

18. The body unit as claimed in claim 1, wherein at least one injection molded part is at least partly molded onto the carrier element and comprises a reinforcing component that reinforces the carrier element.

19. The body unit as claimed in claim 1, wherein at least one injection molded part comprises at least one reinforcing rib and the at least one reinforcing rib reinforces a holding component of the at least one injection molded part.

20. The body unit as claimed in claim 18, wherein at least one reinforcing rib at least partly peripherally embraces the carrier element.

21. The body unit as claimed in claim 18, wherein at least one reinforcing rib is arranged in an internal region of the carrier element.

22. The body unit as claimed in claim 1, wherein the carrier element has at least one through-hole, and at least one injection molded part engages in the at least one through-hole.

23. The body unit as claimed in claim 22, wherein a portion of the at least one injection molded part that engages in the through-hole is molded onto a portion of the reinforcing rib that portion of the reinforcing rib runs over a through-opening.

24. The body unit according to claim 1, wherein the carrier element has a laterally open cross-sectional shape.

25. The body unit as claimed in claim 1, wherein the carrier element is made at least partly from a metallic material.

26. A body unit, comprising a body component that comprises an elongate carrier element and at least one injection molded part, the carrier element is at least partly formed from an injection molded part.

27. The body unit as claimed in claim 1, wherein the carrier element is made at least partly from a material comprising a plastics material.

28. The body unit as claimed in claim 26, wherein the material of the carrier element comprises at least two different materials, wherein one of the at least two different materials has a greater elastic modulus than the other of the at least two different materials.

29. The body unit as claimed in claim 1, wherein the carrier element is at least partly fiber-reinforced.

30. The body unit as claimed in claim 29, wherein the carrier element is made from a fiber-reinforced material.

31. The body unit as claimed in claim 29, wherein the carrier element is fiber-reinforced by a fiber-reinforced reinforcing component.

32. The body unit as claimed in claim 29, wherein the carrier element is fiber-reinforced at least along a portion that, at least in respect of one operating mode, is on the driver's side.

33. The body unit as claimed in claim 29, wherein the carrier element is fiber-reinforced along its entire longitudinal extent.

34. The body unit as claimed in claim 26, wherein the injection molded part is at least partly fiber-reinforced.

35. The body unit as claimed in claim 34, wherein the fiber reinforcement takes the form of a fiber-reinforced layer.

36. The body unit as claimed in claim 34, wherein at least some of the fibers of the fiber reinforcement are entwined with one another.

37. The body unit as claimed in claim 34, wherein at least some fibers of the fiber reinforcement are oriented unidirectionally in at least one ply.

38. The body unit as claimed in claim 34, wherein the fiber reinforcement comprises a plurality of plies having fibers.

39. A body for a motor vehicle, comprising at least one body unit as claimed in claim 1.

40. A motor vehicle having a body unit as claimed in claim 1.

41. The body unit as claimed in claim 1, the at least one injection molded part is at least partly fiber-reinforced.

42. A method for the manufacture of a body unit comprising a body component, wherein the method comprises providing an elongate carrier element and forming at least one injection molded part for the body component, wherein the at least one injection molded part is at least partly molded onto the carrier element.

43. The method as claimed in claim 42, wherein a mold is used for the manufacture of at least the body component, wherein the mold comprises a plurality of mold units that are movable in relation to one another.

44. The method as claimed in claim 42, wherein the mold comprises at least one mold unit that has a mold slide that is displaceable relative to a mold unit base.

45. The method as claimed in claim 42, wherein the formation of at least one injection molded part comprises multi-component injection molding.
